(19) United States
(12) Patent Application Publication
(10) Pub. No.: US 2023/0277400 A1
(43) Pub. Date: Sep. 7, 2023

(54) APPARATUS AND METHOD FOR POSITIONING AN ARTICLE UNDER A PERSON

(71) Applicant: Melior Motus Inc., Halifax (CA)

(72) Inventors: Stephen Douglas BEED, Halifax (CA); Paul LAPSTUN, Sydney (AU)

(21) Appl. No.: 18/179,271

(22) Filed: Mar. 6, 2023

Related U.S. Application Data
(60) Provisional application No. 63/316,787, filed on Mar. 4, 2022.

(51) Int. Cl. A61G 7/10

(52) U.S. Cl. CPC A61G 7/1036; A61G 7/1034; A61G 7/1032; A61G 2200/32

(57) ABSTRACT

A system and method for positioning an article under a person are provided. The system includes an apparatus having a first cover structure and a second cover structure, each having a first surface and a second surface opposite the first surface. The first surface is movable in a first direction and the second surface moves in a second opposite direction. A coupling structure couples the first cover structure and the second cover structure, spacing them to enable the article to be positioned therebetween. The first and second directions of the first and second cover structures are substantially aligned. Movement of the first surfaces of the first and second cover structures in the first direction causes the second surfaces of the first and second cover structures to move the article positioned therebetween in the second direction by the second surfaces.

### CROSS-REFERENCE TO RELATED APPLICATIONS

This application claims the benefit of U.S. Provisional Patent Application No. 63/316,787, filed Mar. 4, 2022, the contents of which are incorporated herein by reference in their entirety.

### FIELD

The specification relates generally to medical equipment. In a particular example, the specification relates to an apparatus and method for positioning an article under a person.

### BACKGROUND

A bed-ridden patient may need to be lifted or turned with the assistance of a sling or wrap, or transferred between beds or stretchers with the assistance of a transfer sheet or board. The positioning of a sheet-like device under a patient can be labor-intensive, particularly in the case of a heavy patient, and can result in injury to care staff. As a result, clinically-advised patient manipulation may sometimes be deferred or neglected, leading to poorer patient outcomes.

### SUMMARY OF THE INVENTION

In one aspect of the present disclosure, there is provided an apparatus for positioning a sheet-like device under a person.

The person may be any person, including, without limitation, a hospital patient, a bed-ridden nursing home resident, a person who has suffered a fall, or in general any person in need of handling, e.g., by care staff, due to a chronic or acute condition.

The sheet-like device may be any sheet-like device, including, without limitation, a sling for hoisting or transferring the person, a wrap for hoisting and reorienting the person, a spinal board for stabilising the person, a transfer sheet or board for transferring the person between beds or stretchers, an air-assisted transfer sheet, an inflatable elevating device, an inflatable trauma stretcher, a soaker pad or sheet, one or more straps, or linen.

The apparatus may comprise at least one roller blanket, the roller blanket comprising a first layer and a second layer, the roller blanket designed to sandwich at least part of the sheet-like device between the two layers.

The roller blanket may be adapted to be moveable beneath the person, thereby to transport the sheet-like device beneath the person.

The roller blanket may be adapted to be easily separated from the sandwiched sheet-like device, and to be moveable from beneath the person, thereby to leave the transported sheet-like device beneath the person.

The roller blanket may be adapted to be moved by pulling or pushing.

The roller blanket may comprise a motor for moving the roller blanket.

The first layer may comprise a set of balls or wheels or rollers to minimise friction, as the roller blanket is moved, between the roller blanket and the underside of the person.

The first layer may comprise at least one continuous belt or track, supported by the balls or wheels or rollers.

The first layer may comprise a motor for propelling the roller blanket.

The second layer may comprise a set of balls or wheels or rollers to minimise friction, as the roller blanket is moved, between the roller blanket and the surface on which the person is recumbent.

The second layer may comprise at least one continuous belt or track supported by the balls or wheels or rollers.

The first layer may have a plate facing the second layer to prevent the balls or wheels or rollers or belt or track from contacting the sheet-like device.

The bottom layer may have a top plate to prevent the balls or wheels or rollers or belt or track from contacting the sheet-like device.

The plates of the two layers may be held apart by standoffs to allow the sandwiched sheet-like device to be easily separated from the roller blanket.

The roller blanket may comprise a mechanism for moving the plates apart, thereby to release the sandwiched sheet-like device.

The bottom layer may comprise a motor for moving the roller blanket.

The motor for moving the roller blanket may be a drum motor inside a drive wheel or drive roller.

The apparatus may comprise a set of advancing rods attachable to the roller blanket to facilitate pulling the roller blanket to and from beneath the person.

The advancing rod may comprise a set of balls or wheels or rollers to minimise friction, as the advancing rod is pulled, between the advancing rod and the underside of the person, and/or between the advancing rod and the surface on which the person is recum bent.

The advancing rod may comprise at least one continuous belt or track, supported by the balls or wheels or rollers.

The advancing rod may comprise a ski or skid to prevent the balls or wheels or rollers or belt or track from contacting the surface on which the person is recumbent.

The apparatus may comprise a set of handles, each handle attachable to a subset of the set of advancing rods, to facilitate pulling of the advancing rods.

The apparatus may comprise straps and a spool, each strap attachable to an advancing rod at one end and the spool at the other end, thereby to allow the straps and their attached advancing rods to be pulled by winding the straps onto the spool.

The spool may be cranked by hand, or the spool may be motorised.

The apparatus may comprise straps, a pulley, and a spreader bar, each strap attachable to an advancing rod at one end and the spreader bar at the other end, the spreader bar attachable to a hoist, the pulley adapted to turn the straps 90 degrees, thereby to convert a vertical force applied by the hoist to the spreader bar into a horizontal force applied by the straps to the advancing rods, thereby to allow the straps and their attached advancing rods to be pulled by lifting the spreader bar using the hoist.

In another aspect of the present disclosure, there is provided an apparatus for positioning a sheet-like device under any difficult-to-handle object for the purposes of subsequent handling.

In another aspect the present disclosure, there is provided an apparatus for transferring a person laterally, the apparatus comprising at least one roller blanket according to any previous aspect of the invention, a belt of a top layer and a belt of bottom layer of the roller blanket selectively configurable to move in unison during positioning of the roller blanket under the person, and configurable to not move in unison during lateral transfer of the person.

The belt of the top layer may be selectively configurable to be stationary while the belt of the bottom layer is moving. The belt of the top layer may be selectively couplable to the belt of the bottom layer.

The belt of the top layer may be selectively configurable to be immovable while the belt of the bottom layer is moving. The belt of the top layer may be selectively couplable to a brake.

The top layer and the bottom layer may be adjacent rather than stacked.

The underside of the belt of the top layer may be configured to be slightly higher than the underside of the belt(s) of the bottom layer, to prevent contact with a surface across which the roller blanket is propelled.

In another aspect of the present disclosure, there is provided an apparatus for transporting any difficult-to-handle object from a first location to a second location, without having to lift the object onto the apparatus.

The apparatus may comprise any roller blanket according to a previous aspect of the invention.

In another aspect of the present disclosure, there is provided a method for positioning a sheet-like device under a person using an apparatus, the apparatus comprising at least one roller blanket according to any previous aspect of the invention, the roller blanket comprising two layers, the method comprising sandwiching the sheet-like device between the layers, moving the roller blanket to beneath the person, thereby positioning the sheet-like device under the person, and moving the roller blanket from beneath the person, leaving the sheet-like device under the person.

In another aspect of the present disclosure, there is provided a method for positioning a sheet-like device under a person using an apparatus, the apparatus comprising at least one roller blanket according to any previous aspect of the invention, the roller blanket comprising two layers, each layer comprising a conveyor, each conveyor comprising a set of balls or wheels or rollers supporting a continuous belt or track, the method comprising sandwiching the sheet-like device between the conveyors, wrapping a leading edge of the sheet-like device around the leading edge of the bottom (or top) conveyor, moving the roller blanket to beneath the person, thereby depositing the sheet-like device under (or above) the bottom (or top) conveyor and therefore under the person, and moving the roller blanket from beneath the person, leaving the sheet-like device under the person.

In another aspect of the present disclosure, there is provided a method for positioning a sheet-like device under a person using a transfer device, the method comprising moving the person from a first location to a second location using the transfer device, placing the sheet-like device in the first location, and moving the person from the second location to the first location using the transfer device.

The transfer device may be any roller blanket according to a previous aspect of the invention.

In a further aspect of the present disclosure, there is provided a system for positioning an article under a person, comprising: an apparatus comprising: a first cover structure and a second cover structure, each of the first cover structure and the second cover structure having a first surface and a second surface opposite the first surface, the first surface being movable in a first direction and the second surface moving in a second direction opposite the first direction in response to the first surface moving in the first direction; and a coupling structure coupling the first cover structure and the second cover structure, the coupling structure being operable to space the first cover structure and the second cover structure to enable the article to be positioned between the second surface of the first cover structure and the second surface of the second cover structure, wherein the first direction of the first cover structure is substantially aligned with the first direction of the second cover structure, wherein the second direction of the first cover structure is substantially aligned with the second direction of the second cover structure, and wherein movement of the first surface of the first cover structure and the first surface of the second cover structure in the first direction causes the second surface of the first cover structure and the second surface of the second cover structure to move the article positioned therebetween in the second direction by the second surface of the first cover structure and the second surface of the second cover structure.

In some or all examples of the further aspect, the first cover structure includes a frame structure, and an array of rotatable elements rotatably mounted on the frame structure, each rotatable element of the array of rotatable elements being rotatable about a rotation axis that is substantially perpendicular to the first direction and substantially parallel to the first surface and the second surface.

In some or all examples of the further aspect, the frame structure includes a plurality of rods on which the array of rotatable elements are rotatably positioned.

In some or all examples of the further aspect, each rotatable element in the array of rotatable elements has a circular cross-section.

In some or all examples of the further aspect, the array of rotatable elements provides the first surface and the second surface of the first cover structure.

In some or all examples of the further aspect, the first cover structure and the second cover structure are generally planar, and wherein the first cover structure has an end portion that extends further in the first direction than the second cover structure, the end portion extending towards a plane of the second cover structure.

In some or all examples of the further aspect, the first cover structure includes a frame structure around which is rotatably positioned at least one endless belt that provides the first surface along one portion thereof, and the second surface along another portion thereof.

In some or all examples of the further aspect, the first cover structure and the second cover structure are generally planar, and wherein the first cover structure having an end portion that extends further in the first direction than the second cover structure, the end portion extending towards a plane of the second cover structure.

In some or all examples of the further aspect, the system can further comprise a set of advancing members, each advancing member of the set of advancing members having a leading end and a connecting end opposite the leading end, each of the set of advancing members being insertable via the leading end thereof between a person and a resting surface on which the person is resting, the connecting end of each advancing member of the set of advancing members being couplable to the apparatus towards an end thereof to draw the apparatus between the person and the resting surface.

In some or all examples of the further aspect, the system further comprises at least one pull structure coupleable to the set of advancing members to facilitate movement of the apparatus between the person and the resting surface.

In some or all examples of the further aspect, the system further comprises a manual drive connectable to the set of advancing members to manually move the apparatus laterally between the person and the resting surface.

In some or all examples of the further aspect, the at least one pull structure is one pull structure, wherein the one pull structure includes a hoist connector interface for connection to a hoist, and wherein the apparatus further comprises a force redirection structure around which the leading ends of the set of advancing members are positioned for redirecting an upward tensile force of the hoist to act laterally on the apparatus.

In some or all examples of the further aspect, the system further comprises an isolation structure that is controllable to selectively isolate the second surface of the first cover structure from the second surface of the second cover structure to inhibit contact therebetween.

In some or all examples of the further aspect, the apparatus further comprises a motor for driving at least one of the first surface of the first cover structure and the first surface of the second cover structure to move in the first direction.

In a still further aspect of the present disclosure, there is provided a method of positioning an article between a person and a resting surface, comprising: positioning a portion of the article between a first cover structure and a second cover structure of an apparatus, each of the first cover structure and the second cover structure having a first surface and a second surface opposite the first surface, the first surface being movable in a first direction and the second surface moving in a second direction opposite the first direction in response to the first surface moving in the first direction, the apparatus having a coupling structure coupling the first cover structure and the second cover structure, the coupling structure spacing the first cover structure and the second cover structure to enable the article to be positioned between the second surface of the first cover structure and the second surface of the second cover structure, wherein the first direction of the first cover structure is substantially aligned with the first direction of the second cover structure, wherein the second direction of the first cover structure is substantially aligned with the second direction of the second cover structure, wherein movement of the first surface of the first cover structure and the first surface of the second cover structure in the first direction causes the second surface of the first cover structure and the second surface of the second cover structure to move the article positioned therebetween in the second direction by the second surface of the first cover structure and the second surface of the second cover structure; wrapping a first end of the article around a first end of the second cover structure; and moving the apparatus between the person and the resting surface with the first end of the second cover structure preceding a remainder of the cover structure to deposit the article between the person and the resting surface.

In some or all examples of the still further aspect, the method further comprises: inserting a leading end of each of a set of advancing members between the person and the resting surface; pushing each of the set of advancing members until the leading ends of the set of advancing members protrudes from under the person; connecting a trailing edge of each of the advancing members to the apparatus towards an end thereof; and drawing the apparatus between the person and the resting surface by applying a tensile force on the leading ends of the set of advancing members.

In some or all examples of the still further aspect, the method further comprises coupling each advancing member of the set of advancing members to at least one pull structure, and drawing the apparatus includes pulling the at least one pull structure.

In some or all examples of the still further aspect, the method further comprises positioning the leading ends of the set of advancing members around a force direction translation structure; connecting the leading ends of the set of advancing members to a pull structure; connecting a hoist to the pull structure; and operating the hoist to pull the leading ends of the set of advancing members.

In yet another aspect of the present disclosure, there is provided a method of moving a person positioned on a resting surface, comprising: positioning an apparatus adjacent to the person, the apparatus including a first cover structure and a second cover structure, each of the first cover structure and the second cover structure having a first surface and a second surface opposite the first surface, the first surface being movable in a first direction and the second surface moving in a second direction opposite the first direction in response to the first surface moving in the first direction, the apparatus further including a coupling structure coupling the first cover structure and the second cover structure, the apparatus further including an isolation structure that is controllable to selectively isolate the second surface of the first cover structure from the second surface of the second cover structure to inhibit contact therebetween; controlling the isolation structure to put the second surface of the first cover structure in contact with the second surface of the second cover structure; driving the apparatus under the person; controlling the isolation structure to isolate the second surface of the first cover structure from the second surface of the second cover structure; driving the apparatus to move the person to a target position; controlling the isolation structure to put the second surface of the first cover structure in contact with the second surface of the second cover structure; and driving the apparatus from between the person and the resting surface.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1A shows a plan view of a patient on a bed, with six advancing rods adjacent to the patient;

FIG. 1B shows the six advancing rods of FIG. 1A positioned underneath the patient;

FIG. 1C shows the six advancing rods of FIG. 1B connected on the left to a roller blanket containing a wrap, and on the right to a pair of pulling tools;

FIG. 1D shows the roller blanket of FIG. 1C pulled underneath the patient via the advancing rods and pulling tools, carrying the wrap with it;

FIG. 1E shows the roller blanket of FIG. 1D pulled away from the wrap, leaving the wrap under the patient;

FIG. 2 shows a roller blanket comprising two roller blanket segments;

FIG. 3 shows a pulling tool comprising a bar with a handle and a set of straps with a connector at the end of each strap;

FIG. 3 shows a pulling tool comprising a bar with a handle, and a set of straps, each strap with a connector at its end for connecting to an advancing rod.

FIG. 4A shows a side elevation view of one embodiment of the advancing rod, comprising an array of rollers;

FIG. 4B shows a plan view of the advancing rod of FIG. 4A;

FIG. 4C shows a side elevation view of another embodiment of the advancing rod, comprising a belt supported by an array of rollers and elevated above a ski;

FIG. 4D shows a plan view of the advancing rod of FIG. 4C;

FIG. 4E shows a side elevation view of another embodiment of the advancing rod, comprising dual belts supported by an array of rollers held by a central frame and elevated above a ski;

FIG. 4F shows a plan view of the advancing rod of FIG. 4E;

FIG. 4G shows a side elevation view of another embodiment of the advancing rod, comprising dual wheels supported by a central frame and elevated above a ski;

FIG. 4H shows a plan view of the advancing rod of FIG. 4G;

FIG. 5A shows a side elevation view of one embodiment of the roller blanket, comprising two layers, each layer comprising an array of balls;

FIG. 5B shows a side elevation view of the roller blanket of FIG. 5A, opened to allow positioning of a wrap between the blanket layers;

FIG. 5C shows a plan view of the roller blanket of FIG. 5A;

FIG. 6A shows a side elevation view of another embodiment of the roller blanket, comprising two layers, each layer comprising an belt supported by an array of rollers and separated from a plate;

FIG. 6B shows a side elevation view of the roller blanket of FIG. 6A with frame and hinge elements in place;

FIG. 6C shows a side elevation view of the roller blanket of FIG. 6B, opened to allow positioning of a wrap between the blanket layers;

FIG. 6D shows a plan view of the roller blanket of FIG. 6B without the belts in place;

FIG. 6E shows a plan view of the roller blanket of FIG. 6B with the belts in place;

FIG. 7A shows a side elevation view of another embodiment of the roller blanket, comprising two layers, each layer comprising a belt supported by an array of rollers;

FIG. 7B shows a side elevation view of the roller blanket of FIG. 7A with frame and hinge elements in place;

FIG. 7C shows a plan view of the roller blanket of FIG. 7B;

FIG. 7D shows a plan view of an alternative embodiment of the roller blanket of FIG. 7C, with internal rather than external frames;

FIG. 7E shows a plan view of the roller blanket of FIG. 7D with the belts in place;

FIG. 8A shows a side elevation view of the advancing rod of FIG. 4D connected to the roller blanket of FIG. 6B;

FIG. 8B shows a side elevation view of the advancing rod of FIG. 4D connected to the roller blanket of FIG. 7B;

FIG. 9A shows an end elevation view of a patient lying on a bed, with the roller blanket of FIG. 6B containing a wrap and positioned just under the left side of the patient;

FIG. 9B shows the roller blanket of FIG. 9A advanced to a position directly under the patient;

FIG. 9C shows the roller blanket of FIG. 9B advanced to just under the right side of the patient, with the wrap partially left behind under the patient;

FIG. 10A shows an end elevation of a patient lying on a bed, with the roller blanket of FIG. 7B positioned just under the left side of a patient, partially containing a wrap wrapped around the front of its bottom belt;

FIG. 10B shows the roller blanket of FIG. 10A advanced to a position directly under the patient, with the wrap transported to a position under the patient;

FIG. 10C shows the roller blanket of FIG. 10B advanced to just under the right side of the patient, with the wrap left behind under the patient;

FIG. 11 shows a roller blanket comprising three roller blanket segments joined laterally, connected to two advancing rods;

FIG. 12A shows a side elevation view of another embodiment of the roller blanket of FIG. 6A, with a front drive roller driving the top belt;

FIG. 12B shows a side elevation view of the roller blanket of FIG. 12A with frame and hinge elements in place;

FIG. 12C shows a side elevation of the roller blanket of FIG. 12B, opened to allow positioning of a wrap between the blanket layers;

FIG. 13A shows a side elevation of another embodiment of the roller blanket of FIG. 7A, with a rear drive roller driving the bottom belt;

FIG. 13B shows a side elevation view of the roller blanket of FIG. 13A with frame and hinge elements in place;

FIG. 13C shows a side elevation view of the roller blanket of FIG. 13B, opened to allow positioning of a wrap between the blanket layers;

FIG. 14A shows a side elevation view of one embodiment of the rear drive roller of the roller blanket of FIG. 13A, adapted for manual propulsion;

FIG. 14B shows a plan view of the drive roller of FIG. 14A;

FIG. 15A shows an end elevation view of a patient on a bed, with a roller blanket positioned on the bed to the left of the patient and containing a wrap, an advancing rod already in place under the patient, and a hand-cranked spool mounted on the right side of the bed;

FIG. 15B shows the advancing rod of FIG. 15A connected on the left to the roller blanket and on the right to a strap from the spool;

FIG. 15C shows the roller blanket of FIG. 15B pulled to a position under the patient via the advancing rod and strap actuated by the hand-cranked spool;

FIG. 15D shows the advancing rod of FIG. 15C removed, and the strap connected directly to the roller blanket;

FIG. 15E shows the roller blanket of FIG. 15D pulled partially clear of the wrap via the strap actuated by the hand-cranked spool, leaving the wrap under the patient;

FIG. 15F shows a plan view of the roller blanket of FIG. 15D, with multiple straps connected to the hand-cranked spool;

FIG. 15G shows an end elevation view of the hand-cranked spool of FIG. 15F, with a clamp for attaching it to a bed;

FIG. 15H shows a plan view of the attachable hand-cranked spool of FIG. 15G;

FIG. 16A shows an end elevation view of a patient on a bed, with an advancing rod already in place under the patient, and connected on the left to a strap from a spool;

FIG. 16B shows the advancing rod of FIG. 16A pulled clear of the patient, bringing the strap with it;

FIG. 16C shows the strap of FIG. 16B connected on the left to a roller blanket containing a wrap, and connected on the right to the hand-cranked spool;

FIG. 16D shows the roller blanket of FIG. 16C pulled to a position under the patient via the hand-cranked strap;

FIG. 16E shows the roller blanket of FIG. 16D pulled partially clear of the wrap via the hand-cranked strap, leaving the wrap under the patient;

FIG. 17A shows an end elevation view of a patient on a bed, with a strap connected to a roller blanket containing a wrap, the strap connected to a motorised lift via a pulley;

FIG. 17B shows the roller blanket of FIG. 17A pulled partially clear of the wrap via the strap and the lift, leaving the wrap under the patient;

FIG. 17C shows a plan view of the roller blanket of FIG. 17A, with multiple straps connected to the lift via the pulley;

FIG. 17D shows an end elevation view of the pulley of FIG. 17C, with a clamp for attaching it to a bed;

FIG. 17E shows a plan view of the attachable pulley of FIG. 17D;

FIG. 18A shows an end elevation view of a patient lying on a bed, with a roller blanket positioned just under the left side of the patient;

FIG. 18B shows the roller blanket of FIG. 18A advanced to a position directly under the patient;

FIG. 18C shows the roller blanket of FIG. 18B transporting the patient laterally to an adjacent bed;

FIG. 18D shows the roller blanket of FIG. 18C advanced to just under the right side of the patient;

FIG. 19A shows a side elevation view of an embodiment of the roller blanket adapted for moving a patient laterally, comprising a pair of separated layers, each layer comprising a belt supported by an array of rollers;

FIG. 19B shows a side elevation view of the roller blanket of FIG. 19A with the top belt in contact with the bottom belt so that they move in unison;

FIG. 19C shows a side elevation view of the roller blanket of FIG. 19A with the frame in place;

FIG. 19D shows a plan view of the roller blanket of FIG. 19C without the belts in place;

FIG. 19E shows a plan view of the roller blanket of FIG. 19C with the belts in place;

FIG. 20A shows a side elevation view of a mechanism for decoupling the belts of the roller blanket of FIG. 19C, with the mechanism in a coupled configuration;

FIG. 20B shows a side elevation view of the mechanism of FIG. 20A with the mechanism in a decoupled configuration;

FIG. 21A shows a plan view of a patient on a bed on top of a transport roller blanket;

FIG. 21B shows a side elevation view of a conveyor part of the transport roller blanket of FIG. 21A;

FIG. 21C shows a side elevation view of a track part of the transport roller blanket of FIG. 21A; and

FIG. 21D shows a side elevation view of the transport roller blanket of FIG. 21A.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Embodiments of the present invention may be used to position a variety of articles under a person. The person may be any person, including, without limitation, a hospital patient, a bed-ridden nursing home resident, a person who has suffered a fall, or in general any person in need of handling, e.g. by care staff, due to a chronic or acute condition. The term “patient”, unless specified otherwise, shall encompass, as used herein, any person requiring such handling. Likewise, the term “bed”, unless specified otherwise, shall encompass, as used herein, any surface on which such a person is resting.

The article may be any item or structure of items having a generally flat top region and a corresponding generally flat bottom region. For example, the article may be a sheet-like device, including, without limitation, a sling for hoisting or transferring the patient, a retention structure such as a wrap for hoisting and reorienting the patient, a spinal board for stabilising the patient, a transfer sheet or board for transferring the patient between beds or stretchers, an air-assisted transfer sheet, an inflatable elevating device, an inflatable trauma stretcher, a soaker pad or sheet, one or more straps, or linen. The term “article”, as used herein, unless specified otherwise, shall encompass, but not be limited to, any item or structure of items having a generally flat top region and a corresponding generally flat bottom region, such as a sheet-like device, or part of a sheet-like device, combination of sheet-like devices, or a wrap, or any other retention structure for securing a person to be positioned under a patient. The term “wrap”, as used herein, unless specified otherwise, shall likewise encompass, but not be limited to, any item or structure of items having a generally flat top region and a corresponding generally flat bottom region, such as a sheet-like device, or part of a sheet-like device, or combination of sheet-like devices, or any other retention structure for securing a person to be positioned under a patient.

Exemplary wraps for elevating and reorienting patients with the assistance of a lift are disclosed in Beed et al., U.S. patent application Ser. No. 17/173,838, “Apparatus and method for reorienting a person”. Exemplary air-assisted transfer devices are disclosed in Foster et al, U.S. Pat. No. 5,483,709, “Low air loss mattress with rigid internal bladder and lower air pallet”; and Weeling, U.S. Pat. No. 5,561,873, “Air chamber-type patient mover air pallet with multiple control features”. The contents of these patents and patent applications are herein incorporated by cross reference.

More generally still, embodiments of the present invention may be used to position a variety of sheet-like devices under any difficult-to-handle object for the purposes of subsequent handling.

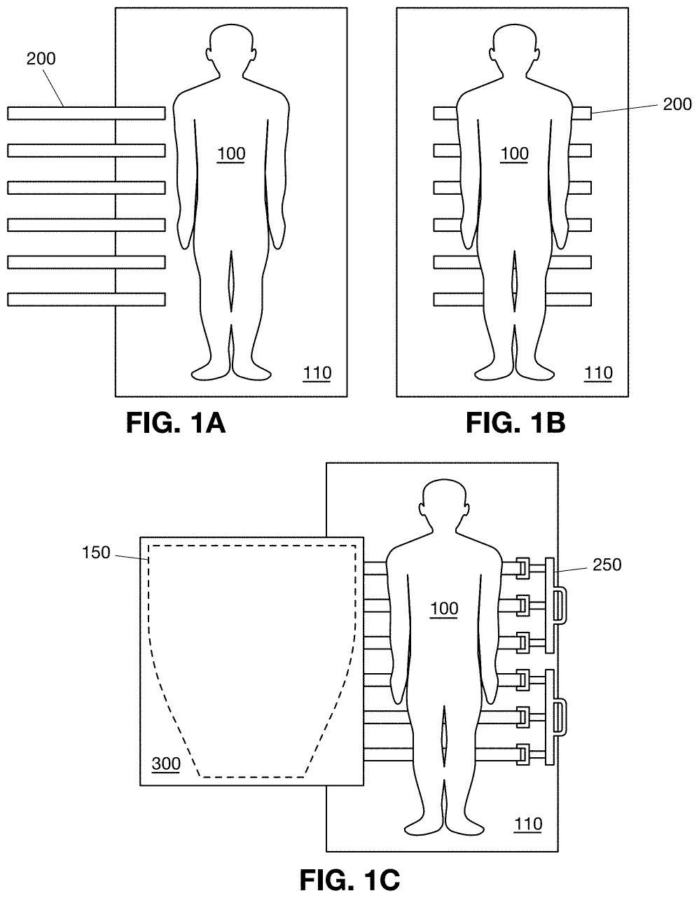

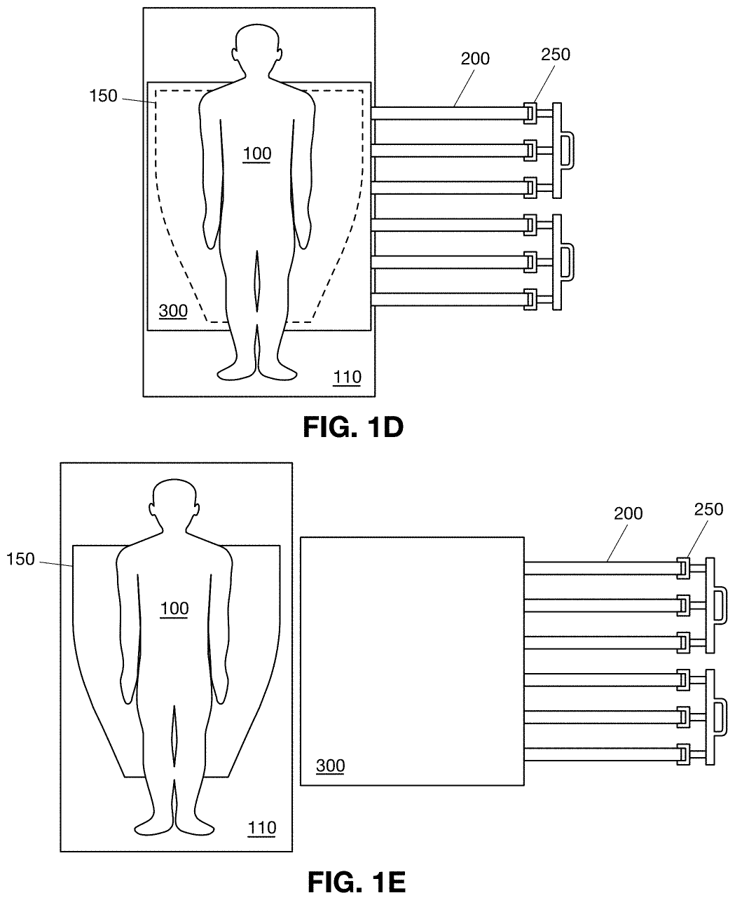

FIGS. 1A through 1E illustrate a procedure for positioning a wrap 150 under a patient 100 using a two-layer roller blanket 300 to transport the wrap 150. The wrap 150 is sandwiched between the two layers of the roller blanket 300. The top layer of the roller blanket 300 has a structure that facilitates its movement relative to the underside of the patient 100. The bottom layer of the roller blanket 300 has a structure that facilitates its movement relative to the surface of the bed 110.

A set of advancing rods 200 are first positioned under the patient 100 (that is, between the patient 100 and the surface of the bed 110), e.g. by pushing the advancing rods 200 under the patient, then connected to the roller blanket 300 containing the wrap 150, and subsequently used to pull the roller blanket 300 under the patient. The roller blanket 300 carries the wrap 150 while being pulled under the patient 100. The roller blanket 300 is then pulled out from under the patient 100, leaving the wrap 150 behind.

FIG. 1A shows a plan view of the patient 100 on the bed 110, with six advancing rods 200 adjacent to the patient 100. FIG. 1B shows the six advancing rods 200 positioned underneath the patient 100. Each advancing rod 200 is positioned manually, one at a time. The advancing rod 200 is designed to minimise friction with the underside of the patient 100 and the bed 110, and thus be easy to position.

FIG. 1C shows the six advancing rods 200 of FIG. 1B connected on the left to the roller blanket 300 containing the wrap 150, and on the right to a pair of pulling tools 250. FIG. 1D shows the roller blanket 300 pulled underneath the patient 100 via the advancing rods 200 and the pair of pulling tools 250, carrying the wrap 150 with it. The pair of pulling tools 250 is designed to be pulled using a pair of hands. Depending on the size of the roller blanket 300, a different number of advancing rods 200 may be utilised, i.e. fewer or more, and the number of advancing rods 200 connected to each pulling tool 250 may differ accordingly. In addition, a different number of pulling tools 250 may be utilised, operated by one or more care staff. The dimensions of the pulling tools may be varied accordingly.

FIG. 1E shows the roller blanket 300 pulled away from the wrap 150, leaving the wrap 150 under the patient 100. The trailing (left) edge of the wrap 150 may be lightly secured or retained to facilitate its separation from the roller blanket 300 when the roller blanket 300 is pulled out from under the patient 100. For example, if the wrap 150 incorporates handles or loops along its trailing edge, then these may be used by care staff to hold on to the wrap 150 as the roller blanket 300 is pulled out, either directly, or indirectly via straps and/or other suitable retention devices (not shown). Additionally or alternatively, the wrap 150 can be dimensioned and/or positioned between the top and bottom layers of the roller blanket 300 so that it protrudes beyond the trailing edge of the roller blanket 300 to facilitate grasping thereof.

The roller blanket may be composed of a number of roller blanket segments, joined together to accommodate the size of a particular wrap.

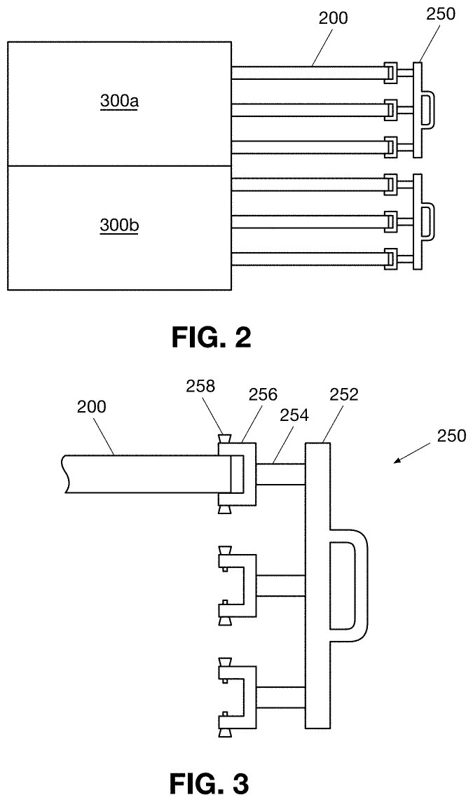

FIG. 2 shows a roller blanket 300 comprising two adjacent roller blanket segments 300a and 300b.

The two layers of a roller blanket 300 (or roller blanket segment) may be fully separable, and may fold along at least one line, for more compact transport and storage.

FIG. 3 shows the pulling tool 250 comprising a bar 252 with a handle, and a set of straps 254 extending fro the bar 252. Each strap 254 has a connector 256 at its end for connecting to an advancing rod 200. Each connector 256 has a pair of sprung pins 258 for engaging with its corresponding advancing rod 200. While a particular type of connector for the pulling tool is illustrated, it will be understood that any suitable connector for connecting the handle(s) to the advancing rod(s) 200 can be employed.

If the roller blanket 300 is pulled via a small number of connection points above and below the torso of the patient 100, then the advancing rods 200 can optionally be dispensed with, and the straps 254 can be connected directly to the roller blanket 300. The head and/or legs of the patient 100 can be lifted as appropriate in order to connect the straps 254.

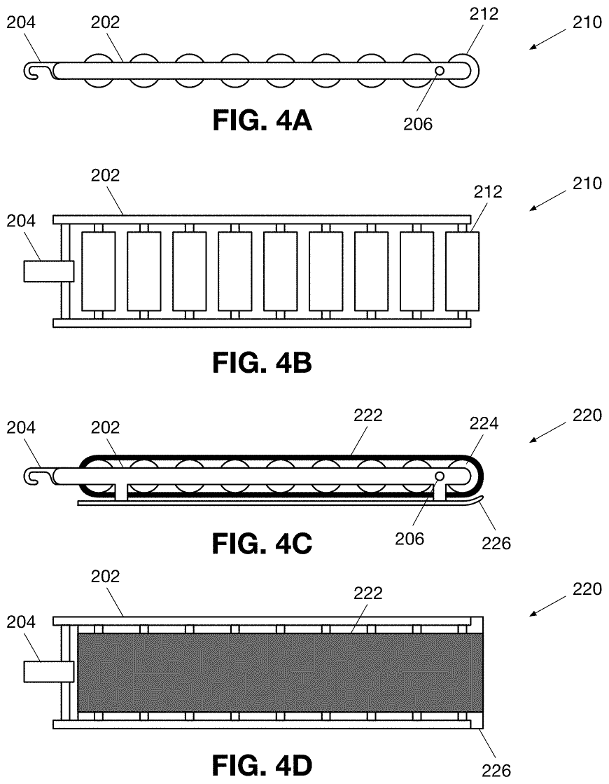

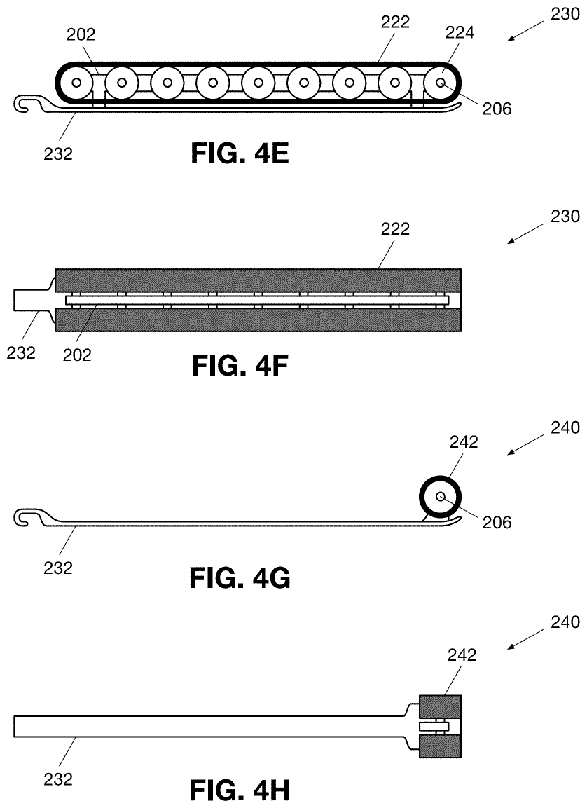

FIG. 4A shows a side elevation view of one embodiment 210 of the advancing rod 200, comprising an array of rollers 212 held by a frame 202. A tow hook 204 is provided at the trailing (left) end for connecting to a roller blanket 300. A pair of connector holes 206 are provided for engaging with the pulling tool pins 258. FIG. 4B shows a corresponding plan view.

Since the rollers 212 are in direct contact with both the underside of the patient 100 and the surface of the bed 110, they are subject to friction with both surfaces, and may roll or slide relative to either surface depending on which surface exhibits greater friction. There is also a chance that the rollers 212 may pinch one of the surfaces they're in contact with.

FIG. 4C shows a side elevation view of an advancing rod 220 in accordance with another embodiment, comprising an endless belt 222 (generally referenced herein simply as a belt) supported by an array of rollers 224 elevated above a ski 226. The belt 222 ensures uniform contact with the patient 100 and mitigates the possibility of pinching. The ski 226 prevents the belt 222 from contacting the surface of the bed 110, thus allowing the belt 222 to remain stationary in contact with the underside of the patient 100, and move freely over the rollers 224 as the advancing rod 220 advances, i.e. the belt 222 acts as a track for driving the advancing rod 220 along the underside of the patient 100. The ski 226 has a smooth surface that allows it to slide along the surface of the bed 110 with minimal friction. FIG. 4D shows a corresponding plan view of the advancing rod 220.

FIG. 4C shows the belt 222 and rollers 224 having smooth surfaces, but the rollers 224 may also be sprockets, and the belt 222 may be perforated or chain-like to engage with the sprockets. This applies equally to any other roller-supported belts shown in the Figures or described in this specification.

FIG. 4E shows a side elevation view of an advancing rod 230 in accordance with another embodiment, comprising dual belts 222 supported by an array of rollers 224 held by a central frame 202 and elevated above a ski 232. The ski 232 incorporates a tow hook at its trailing (left) end. FIG. 4F shows a corresponding plan view of the advancing rod 230. Advancing rod 230 differs from advancing rod 220 in not having a laterally external frame 202.

FIG. 4G shows a side elevation view of an advancing rod 240 in accordance with another embodiment, comprising dual wheels 242 supported by a central frame 202 and elevated above a ski 232. FIG. 4H shows a corresponding plan view of the advancing rod 240.

A number of designs are possible that are intermediate between advancing rods 230 and 240, i.e. with shorter belts 222 and fewer rollers 224. Advancing rod 230, with a full-length belt 222, is at one extreme. Advancing rod 240, with its single pair of wheels, is at the other extreme.

At an absolute minimum, the advancing rod 200 may be a thin slat or rod with a rounded nose to prevent injury to the patient, and a tow hook or other suitable connector at its tail.

A tool can be provided to facilitate pushing on the trailing (left) end of an advancing rod when positioning it under a patient 100. For example, the tool can comprise an easily-grasped T-bar with a slot for receiving a tow hook or other connector of the advancing rod.

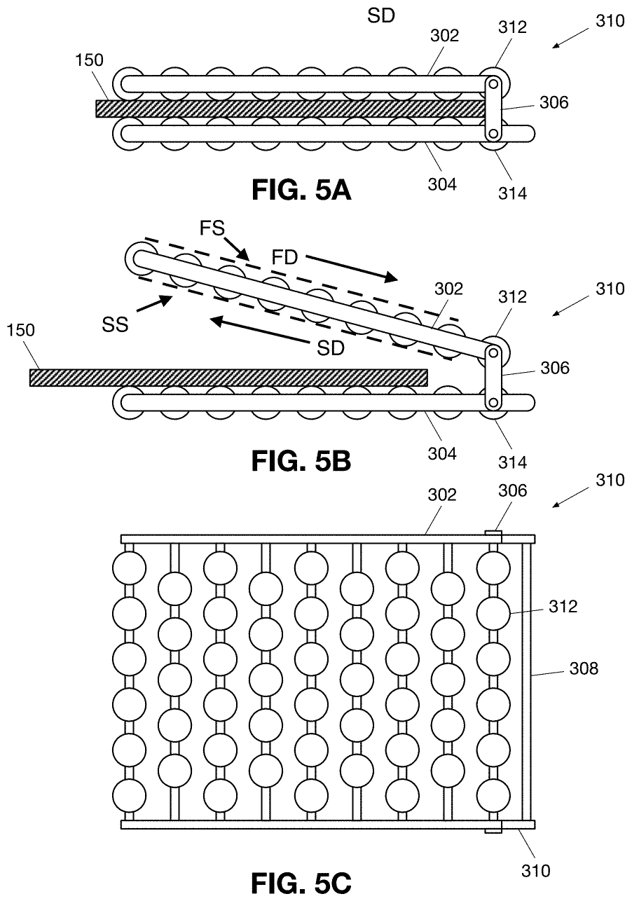

FIG. 5A shows a side elevation view of a roller blanket 310 in accordance with another embodiment comprising two cover structures in the form of layers designed to sandwich a wrap 150. The top layer comprises an array of balls 312 held in a frame 302. The bottom layer comprises an array of balls 314 held in a frame 304. Each array of the arrays of balls 312, 314 provides a first surface FS and a second surface SS opposite the first surface (labelled in FIG. 5B), the first surface being movable in a first direction FD and the second surface moving in a second direction SD opposite the first direction in response to the first surface being moved in the first direction (labelled in FIG. 5B). The frames 302 and 304 of the two layers are joined by a coupling structure 306 which allows relative rotation of the two frames and therefore acts as a hinge. The coupling structure 306 allows positioning the first layer relative to the second layer to enable the article to be received between the second surface of the first layer and the second surface of the second layer. The first direction FD of the first layer is substantially aligned with the first direction of the second layer and the second direction SD of the first layer is substantially aligned with the second direction of the second layer when the first layer and the second layer are coupled together.

FIG. 5B shows a side elevation view of the roller blanket 310, opened to allow insertion of a wrap 150 between the blanket layers.

FIG. 5C shows a plan view of the roller blanket 310. A tow bar 308 is provided at the leading (right) end to connect to a tow hook 204 of an advancing rod 200.

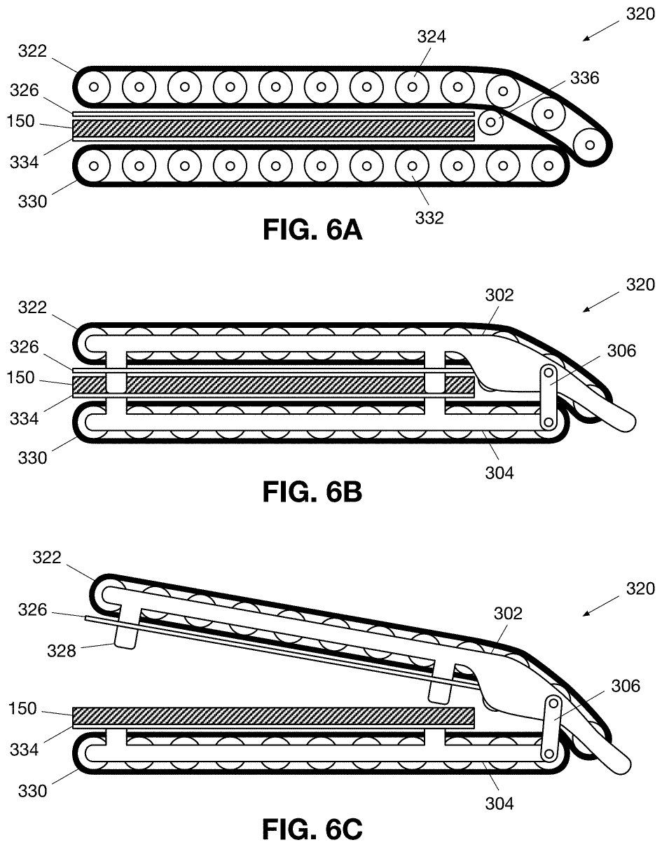

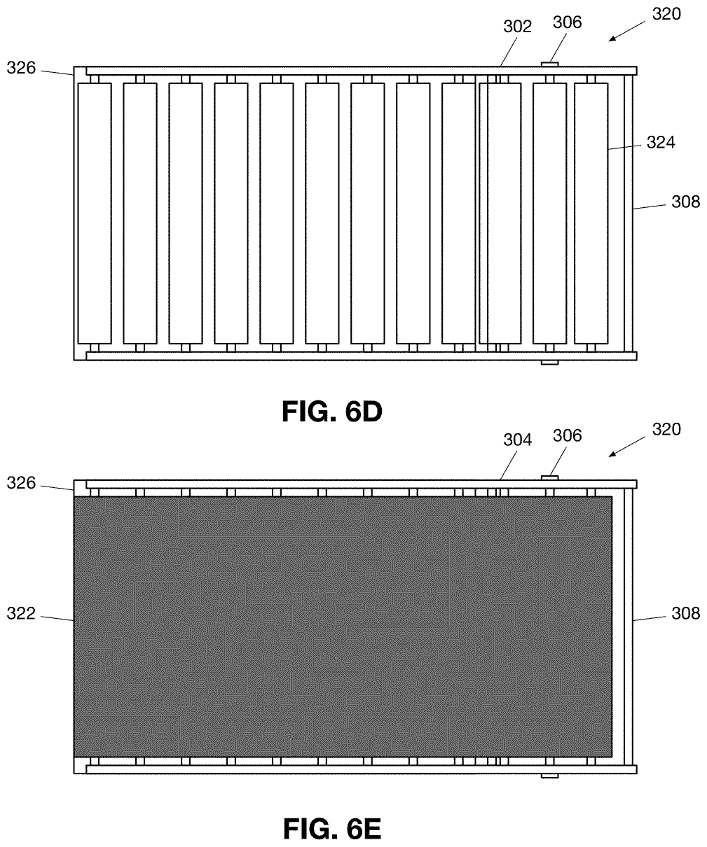

Since the top balls 312 are in direct contact with the underside of the patient 100 and with the top surface of the sandwiched wrap 150, they are subject to friction with both surfaces, and may roll or slide relative to either surface depending on which surface exhibits the greater friction; and since the bottom balls 314 are in direct contact with the surface of the bed 110 and with the bottom surface of the sandwiched wrap 150, they are subject to friction with both surfaces, and may roll or slide relative to either surface depending on which surface exhibits the greater friction. There is also a chance that the balls 312 or 314 may pinch one of the surfaces they're in contact with. Direct contact between the balls 312 and 314 and the sandwiched wrap 150 may also make it difficult for the wrap 150 to be separated from the roller blanket 310 when the roller blanket 310 is removed from under the patient 100. These problems may be avoided through the use of plates and standoffs, as discussed below in relation to FIGS. 6A and 6B.

FIG. 6A shows a side elevation view of a roller blanket 320 in accordance with another embodiment, comprising two cover structures in the form of layers designed to sandwich a wrap 150. The top layer comprises a belt 322 supported by an array of rollers 324 and separated from a plate 326 below the belt 322. The bottom layer comprises a belt 330 supported by an array of rollers 332 and separated from a plate 334 above the belt 330. The upper plate 326 prevents the upper belt 322 from contacting the sandwiched wrap 150, thus allowing the upper belt 322 to remain stationary in contact with the underside of the patient 100, and move freely over the upper rollers 324 as the roller blanket 320 advances. I.e. the belt 322 acts as a track for driving the roller blanket 320 along the underside of the patient 100. The lower plate 334 prevents the lower belt 330 from contacting the sandwiched wrap 150, thus allowing the lower belt 330 to remain stationary in contact with the surface of the bed 110, and move freely over the lower rollers 332 as the roller blanket 320 advances; i.e., the belt 330 acts as a track for driving the roller blanket 320 along the surface of the bed 110.

FIG. 6B shows the roller blanket 320 with frame and hinge elements in place. A top frame 302 holds the top rollers 324 and plate 326. A bottom frame 304 holds the bottom rollers 332 and bottom plate 334. Frames 302 and 304 are joined by a hinge bracket 312.

FIG. 6C shows a side elevation view of the roller blanket 320, opened to allow positioning of a wrap 150 between the blanket layers.

The top plate 326 has standoffs 328 that ensure that a gap is maintained between the top plate 326 and the bottom plate 334. The standoffs 328 are sized to exceed the thickness of a wrap 150, to allow the wrap 150 to slide out from between the plates 326, 334 when it needs to be separated from the roller blanket 320 as the roller blanket 320 is removed from under the patient 100.

Alternatively, the standoffs 328 can be omitted, resulting in the wrap 150 being more tightly sandwiched by the plates 326 and 334. A mechanism for pushing the plates 326, 334 apart can then be included, operable once the wrap 150 is positioned under the patient 100 and it needs to be separated from the roller blanket 320. The mechanism can operate to push the plates 326, 334 apart evenly, or can operate just to push the plates apart at the trailing (left) end, relying on the hinge 306 at or towards the leading (right) end. The mechanism for pushing the plates apart can be driven electrically, hydraulically, pneumatically, or by hand. It may, for example, comprise one or more pistons, inflatable bladders, of scissor mechanisms installed along the lateral edges of the roller blanket 320, adjacent to where the wrap 150 is sandwiched.

FIG. 6D shows a corresponding plan view of the roller blanket 320 without the belts in place, while FIG. 6E shows a plan view of the roller blanket 320 with the belts in place. A tow bar 308 is provided at or towards the leading (right) end for connection of a tow hook of an advancing rod.

In an alternative embodiment of roller blanket 320, the bottom layer comprises, in place of belt 330 and rollers 332, one or more skis fixed to frame 304 and/or bottom plate 334, designed to slide across the surface of bed 110. That is, the alternative roller blanket has a similar configuration to advancing rod 220 as previously described.

The frames 302 and 304 of the roller blanket 320 are shown as rigid. They may also be partially or fully articulated via one or more joints along their length to allow the roller blanket 320 to conform more flexibly to the underside of the patient 100 or to the surface of the bed 110. The roller blanket 320 may also be partially or fully articulated laterally, by segmenting the rollers 324 and 332 and interspersing joints. Associated structures, such as the plates 326 and 334, may be correspondingly articulated, segmented, or flexible. Lateral or longitudinal articulation or flexibility applies equally to any other embodiment of the roller blanket 300 shown in the Figures or described in this specification.

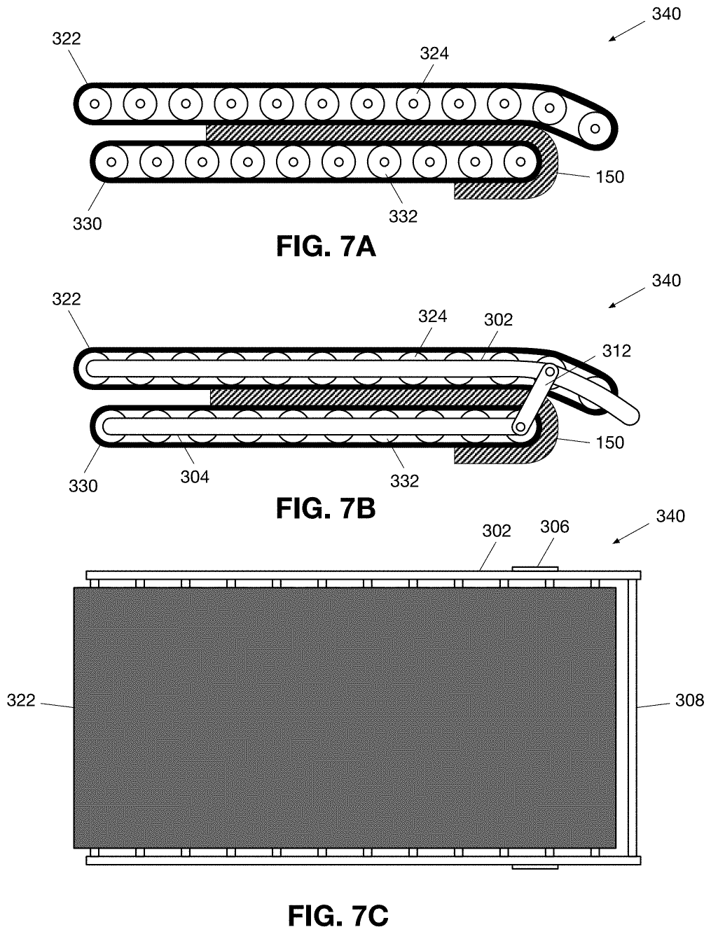

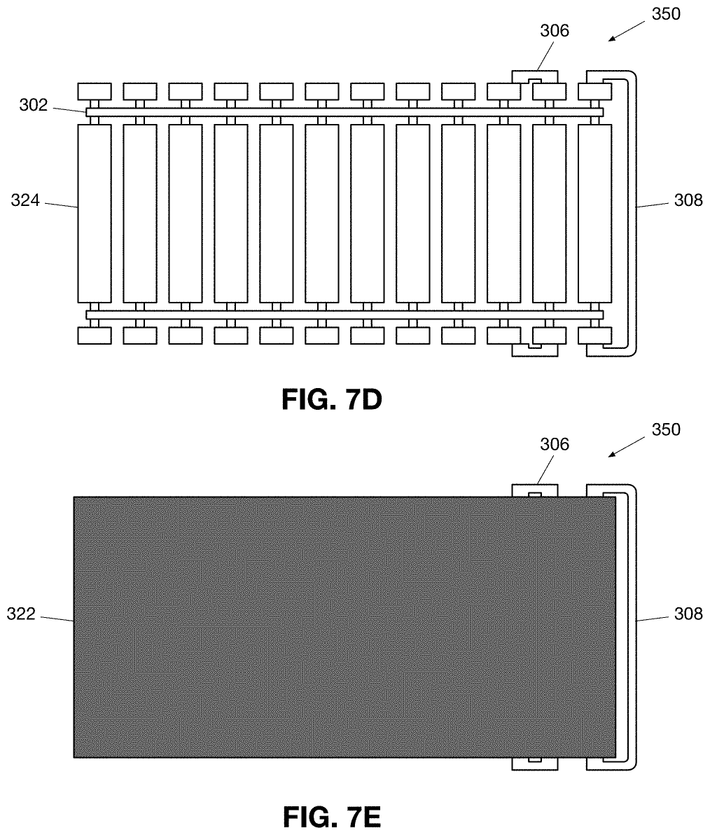

FIG. 7A shows a side elevation view of a roller blanket 340 in accordance with another embodiment, comprising two cover structures in the form of layers designed to sandwich a wrap 150. The top layer comprises a belt 322 supported by an array of rollers 324. The bottom layer comprises a belt 330 supported by an array of rollers 332. The top belt 322 and bottom belt 330 are both in contact with the sandwiched wrap 150.

FIG. 7B shows a side elevation view of the roller blanket 340 with frame and hinge elements in place. A top frame 302 holds the top rollers 324. A bottom frame 304 holds the bottom rollers 332. Frames 302 and 304 are joined by a hinge bracket 312 toward a leading (right) end.

FIG. 7C shows a corresponding plan view of the roller blanket 340. A tow bar 308 is provided at the leading (right) end for connection by a tow hook of an advancing rod.

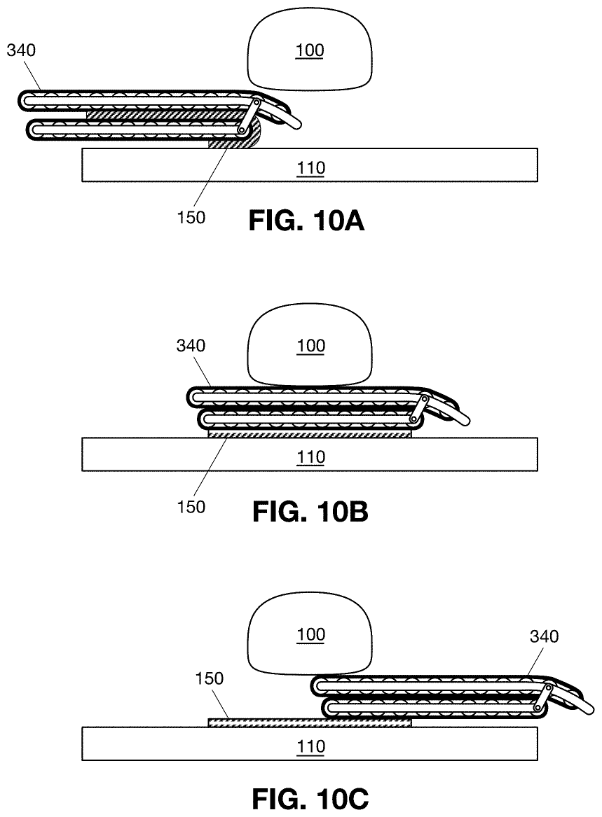

As a result of the sandwiched wrap 150 being in contact with the belts 322 and 330, each belt 322, 330 acts as a conveyor for the wrap 150. As the roller blanket 340 advances on the surface of a bed 110, the sandwiched wrap 150 is transported through the roller blanket 340 at the same velocity relative to the roller blanket 340 as the velocity of the roller blanket 340 relative to the surface of the bed 110. This is discussed in more detail below with reference to FIGS. 10A through 10C.

As previously described, the hinge bracket 312 allows the layers of the roller blanket 340 to rotate relative to each other. By allowing rotation at both ends, the hinge bracket 312 also allows the gap between the underside of the top belt 322 and the top surface of the bottom belt 330 to vary according to the actual thickness of the sandwiched wrap 150, and, in the absence of a wrap 150, for the gap to close entirely so that the belts 322 and 330 are in contact with each other. In addition, to preserve the relative alignment of the belts 322 and 330, the hinge bracket 312 may itself be jointed or otherwise able to vary in length.

FIG. 7D shows a plan view of a roller blanket 350 in accordance with another embodiment, with internal frames 302 and 304 rather than external frames 302 and 304. For clarity, the figure only shows the top layer, without the belt 322 in place. The top rollers 324 are segmented to accommodate the internal top frames 302. The bottom rollers 332 (not shown), are likewise segmented to accommodate internal bottom frames 304 (not shown). The use of internal frames allows the belts 322 and 330 to span the full width of the roller blanket 350, with the exception of any elements that need to span the edges of the belts, such as the hinge brackets 306 and the tow bar 308. The use of internal frames applies to equally to any other embodiment of the roller blanket 300 shown in the Figures or described in this specification.

FIG. 7A also illustrates another possible embodiment of the advancing rod 200, comprising stacked belts (instead of a single belt per FIG. 4C), or dual stacked belts (instead of dual single belts per FIG. 4E).

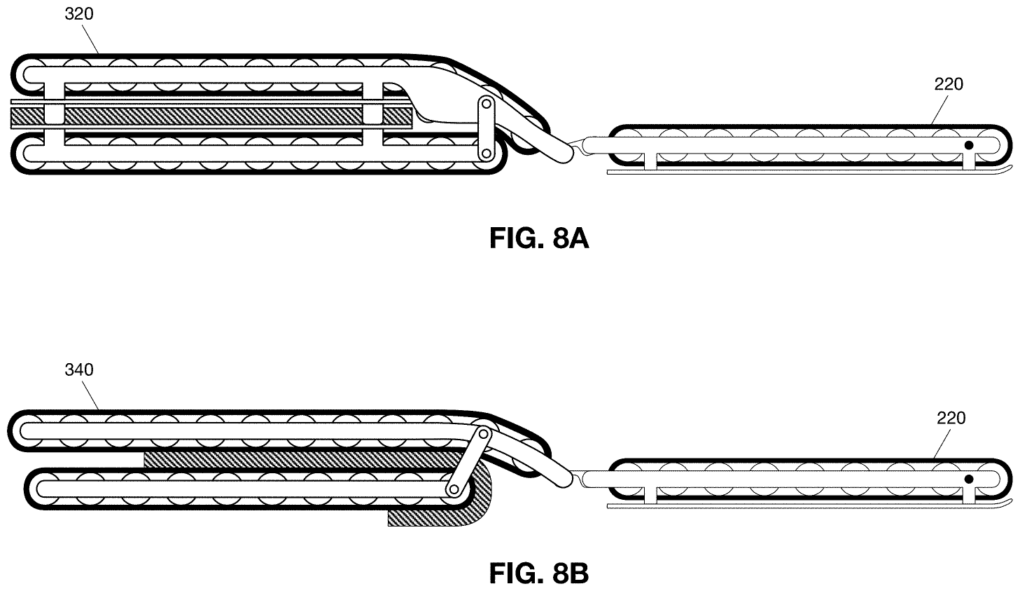

FIG. 8A shows a side elevation view of the advancing rod 220 of FIG. 4C connected to the roller blanket 320 of FIG. 6B.

FIG. 8B shows a side elevation view of the advancing rod 220 of FIG. 4C connected to the roller blanket 340 of FIG. 7B.

In both cases the tow hook 204 of the advancing rod 220 is connected to the tow bar 308 of the roller blanket 320 or 340.

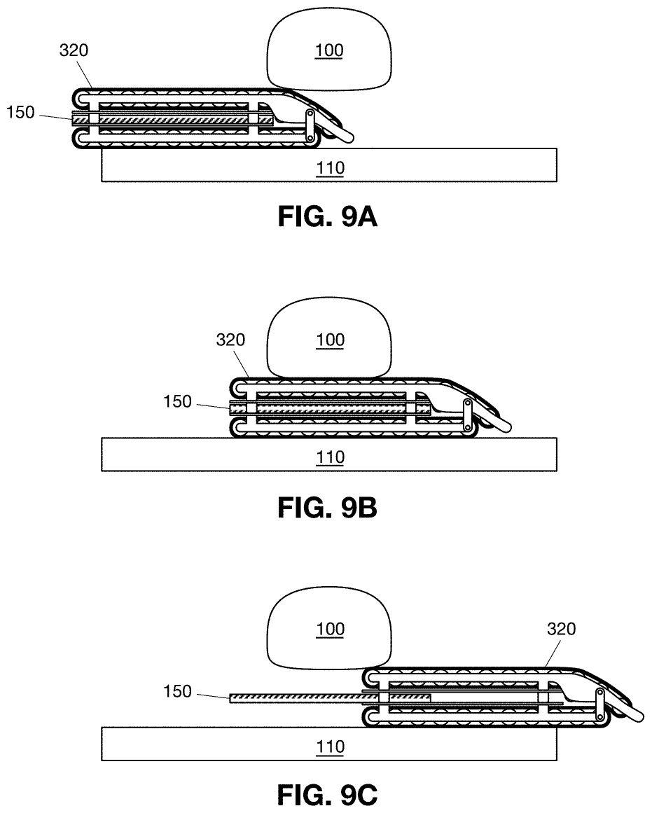

FIGS. 9A through 9C illustrate the procedure for positioning a wrap 150 under a patient 100 using the roller blanket 320 of FIG. 6B. The steps mirror the steps illustrated in FIGS. 1C through 1E. Advancing rods 200 may be used for pulling in the usual way, connected to the roller blanket 320 per FIG. 8A, but are omitted for clarity.

FIG. 9A shows an end elevation view of the patient 100 lying on a bed 110, with the roller blanket 320 containing a wrap 150 and positioned just under the left side of the patient 100. FIG. 9B shows the roller blanket 320 advanced to a position directly under the patient 100. FIG. 9C shows the roller blanket 320 advanced to just under the right side of the patient 100, with the wrap 150 partially left behind under the patient.

In FIGS. 9A through 9C, the patient 100 is shown in a fixed position relative to the bed 110 in order to most clearly illustrate the progression of the roller blanket 320 under the patient 100. In practice, the patient 100 may be resting on the bed 110 where no part of the roller blanket 320 is between the patient 100 and bed 110. For clarity, the same approach is taken in other similar Figures.

FIGS. 10A through 10C illustrate the procedure for positioning a wrap 150 under a patient 100 using the roller blanket 340 of FIG. 7B. The steps mirror the steps illustrated in FIGS. 1C through 1E. Advancing rods 200 may be used for pulling in the usual way, connected to the roller blanket 340 per FIG. 8B, but are omitted for clarity.

FIG. 10A shows an end elevation view of the patient 100 lying on a bed 100, with the roller blanket 340 positioned just under the left side of the patient 100, partially containing a wrap 150 wrapped around the front of its bottom belt. FIG. 10B shows the roller blanket 340 advanced to a position directly under the patient 100, with the wrap 150 transported to a position under the patient 100. FIG. 10C shows the roller blanket 340 advanced to just under the right side of the patient 100, with the wrap 150 left behind under the patient 100. As the roller blanket 340 advances, the trailing part of the wrap 150 is naturally transported forward, and deposited on the surface of the bed 110 as it wraps around the front of the bottom roller.

FIG. 10C shows the roller blanket 340 advanced to the right side of the patient 100. However, once the wrap 150 is fully deposited under the patient, per FIG. 10B, the roller blanket 340 can equally effectively return to the left of the patient 100.

FIG. 10A shows the wrap 150 wrapped downwards around the front of the bottom belt, resulting in it being deposited under the roller blanket 340 as shown in FIG. 10B. Alternatively, the wrap 150 can be wrapped upwards around the front of the top belt, resulting in it being deposited on top of the roller blanket 340. Either way the wrap 150 is under the patient 100 once the roller blanket 340 is removed. In addition, simultaneous upwards and downwards transport makes it possible to position a first wrap 150 while at the same time removing a second wrap 150.

As a further alternative, the wrap 150 may be placed inside the trailing (left) end of the roller blanket 340 at the start. As the roller blanket advances to a position under the patient 100, the wrap 150 is also transported to a position under the patient (advancing at twice the speed of the roller blanket 340, as previously described). The hinge bracket 312 joining the layers of the roller blanket 340 can be detachable from either or both layers, allowing the layers to be separated. This in turn can allow the wrap 150 to be utilised, once in place under the patient 150, with the separated layers of the roller blanket 340 still in place. This can be particularly effective if the function of the wrap 150 is temporary, after which it is intended to be removed again. At this point the layers of the roller blanket 340 can be re-joined, and the roller blanket 340 can be used to remove the wrap 150 from under the patient 100, either by advancing to the right side of the patient 100, or retreating to the left side of the patient 100.

The “inverted feeding” technique illustrated in FIGS. 10A through 10C generally only requires a roller blanket 340 half as long as the width of the wrap 150, since by the time the roller blanket 340 is halfway under the patient 100, half of the wrap 150 will have been deposited under the patient 100.

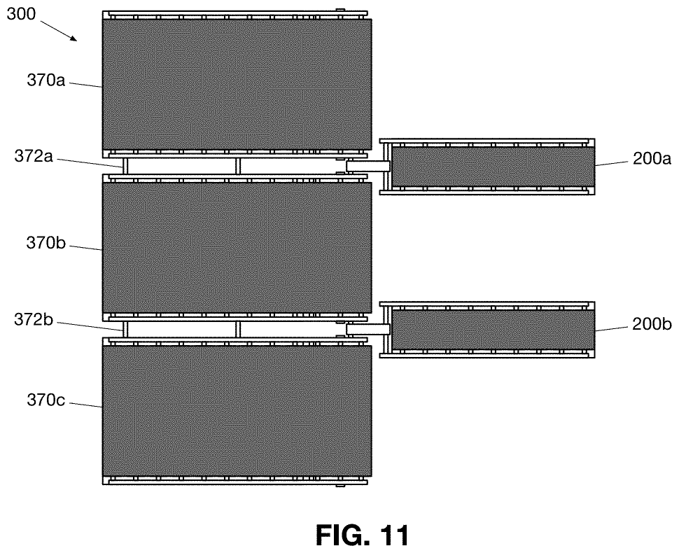

As shown in FIG. 11, rather than connecting advancing rods 200 to a tow bar 308 in front of the leading edge of a roller blanket 300, a roller blanket can instead be divided into multiple roller blanket segments 370 joined laterally by connectors 372, and the connectors 372 can act as tow bars 308. Removing the leading tow bar 308 removes a possible source of friction between the roller blanket 300 and the underside of the patient 100. In FIG. 11, roller blanket segment 370 can be any roller blanket 300 previously described, and advancing rod 200 can be any advancing rod 200 previously described.

A roller blanket 300 may be self-propelled rather than being pulled, obviating the need for advancing rods 200, and therefore also obviating the need for tow bar(s) 308.

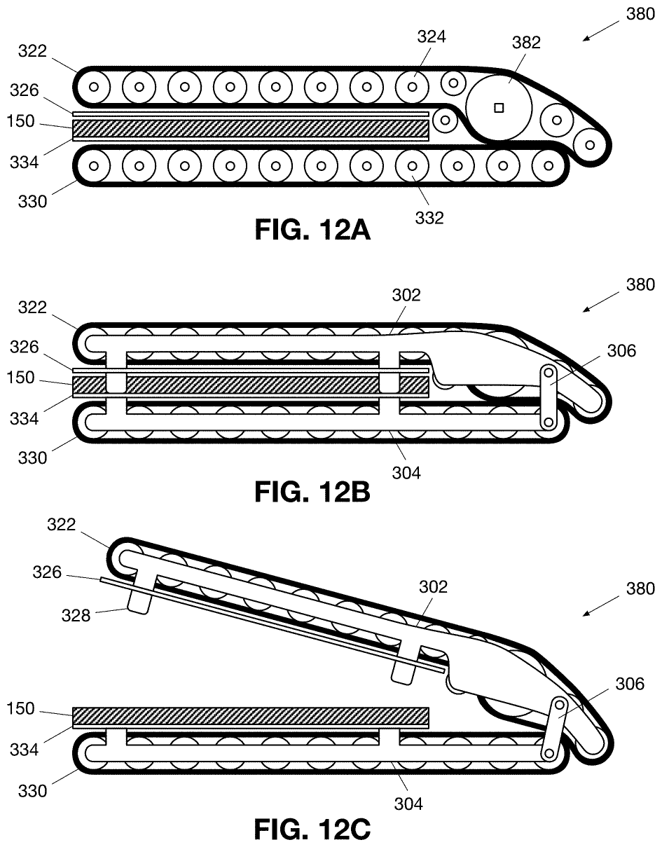

FIG. 12A shows a side elevation view of a roller blanket 380 in accordance with another embodiment, with a front drive roller 382 driving the top belt 322. The drive roller 382 may be any suitable roller with a drum motor.

FIG. 12B shows a side elevation view of the roller blanket 380 with frame and hinge elements in place. FIG. 12C shows a side elevation view of the roller blanket 380 opened to allow positioning of a wrap 150 between the blanket layers.

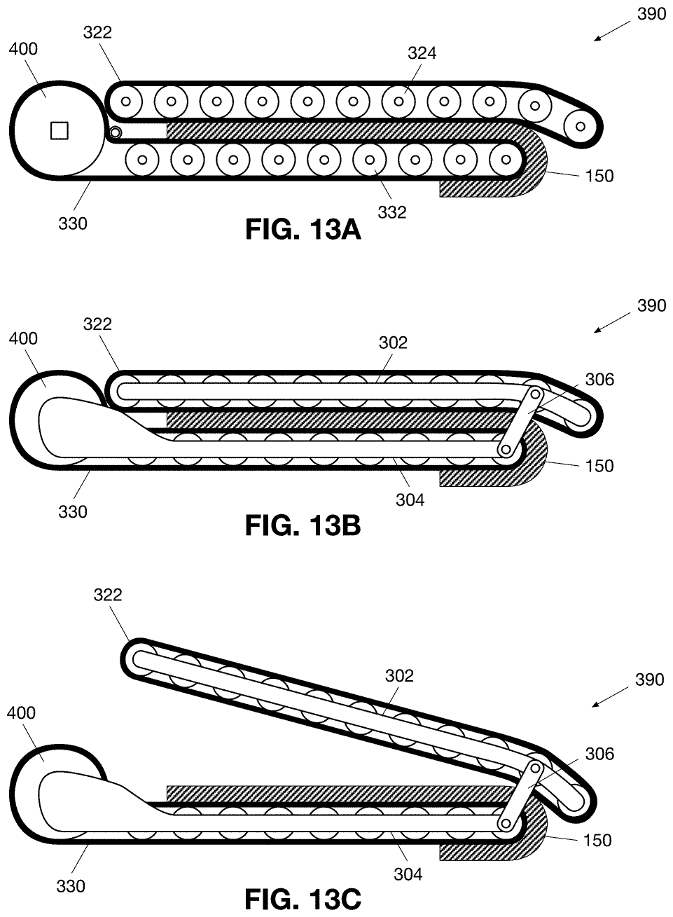

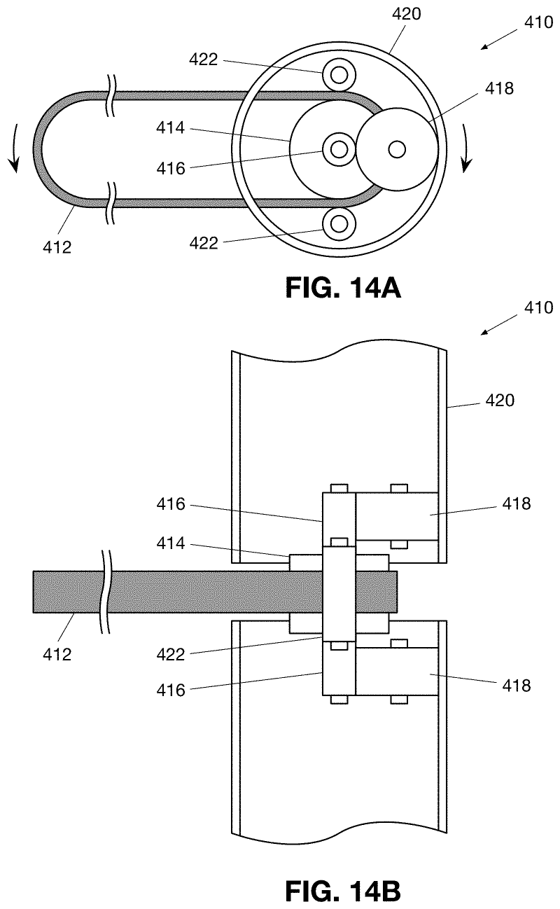

FIG. 13A shows a side elevation view of a roller blanket 390 in accordance with another embodiment, with a rear drive roller 400 driving the bottom belt 330. The drive roller 400 may be any suitable roller with a drum motor, or a manually-driven roller as described below in relation to FIGS. 14A and 14B.

FIG. 13B shows a side elevation view of the roller blanket 390 with frame and hinge elements in place. FIG. 13C shows a side elevation view of the roller blanket 390 opened to allow positioning of a wrap 150 between the blanket layers.

Any motorised roller can be powered by a battery incorporated in the roller blanket 300 or in the roller. The battery can be rechargeable. A motorised roller can also be powered by cable from an external AC or DC power supply. Control of a motorised roller can be via controls incorporated in the roller blanket 300, and/or can be via a wired or wireless remote control device, including a general-purpose device such as a mobile phone or similar. The roller blanket 300 can incorporate control electronics, and can incorporate wireless radiofrequency communications electronics to allow remote control.

As previously discussed in relation to FIGS. 10A through 10C, roller blanket 340, and therefore by extension roller blanket 390, can be driven in under a patient 100 to deposit a wrap 150, and then driven back out the way it came. Thus, the bottom drive belt 330 immediately above the rear drive roller 400 of the roller blanket 390 need never come into contact with the underside of the patient 100. Alternatively, if the roller blanket 390 is to be driven fully under the patient 100, then the drive roller 400 can be tucked in under the top drive belt 322, requiring a smaller drive roller 400 and/or resulting in a thicker roller blanket 390 (at least at the trailing end). Alternatively, a smooth-surfaced guard can be provided directly above the drive roller 400, adapted to slide under the patient 10 with minimal friction.

FIG. 14A shows a side elevation view of one embodiment 410 of the rear drive roller 400 of the roller blanket 390, adapted for manual propulsion. FIG. 14B shows a corresponding plan view.

The drive roller 410 is manually driven via drive belt 412. Pulling the top of the drive belt 412 away from the drive roller 410 causes the drive roller 410 to rotate clockwise. The bottom belt 330 of roller blanket 390 is therefore also driven clockwise, i.e. driving roller blanket 390 forwards. The drive belt 412 engages with a master roller 414, which is directly coupled to a reduction roller 416. The reduction roller 416 engages with a transfer roller 418, which in turn engages with the inside of drum 420, thereby powering the drive roller 410. A pair of pinch rollers 422 hold the drive belt 412 against the master roller 414. The relative diameters of the master roller 414 and reduction roller 416 determine a reduction gearing ratio. A reduction gearing ratio of N:1 results in an absolute gearing ratio of (N−1):1, i.e. between the absolute backwards movement of the drive belt 412 and the absolute forward movement of the roller blanket 390. A reduction gearing ratio of 3:1, as shown in FIG. 14A, results in an absolute gearing ratio of 2:1. The diameter of master roller 414 must exceed the diameter of reduction roller 416.

The bottom belt 330 and the drum 420 are both split to allow the drive belt 412 to reach the master roller 414.

Although the moving components of the drive roller 410 are shown with smooth surfaces that rely on high-friction contact, some or all of the components may be toothed gears, and the drive belt 412 may be correspondingly perforated or similar.

Rather than relying on direct manual effort to pull a roller blanket 300 under a patient 100, a hand-cranked spool 500 may be used to amplify the power of a single person. The higher the gearing ratio of the crank the lower the instantaneous effort required from care staff, at the cost of slower movement of the roller blanket 300.

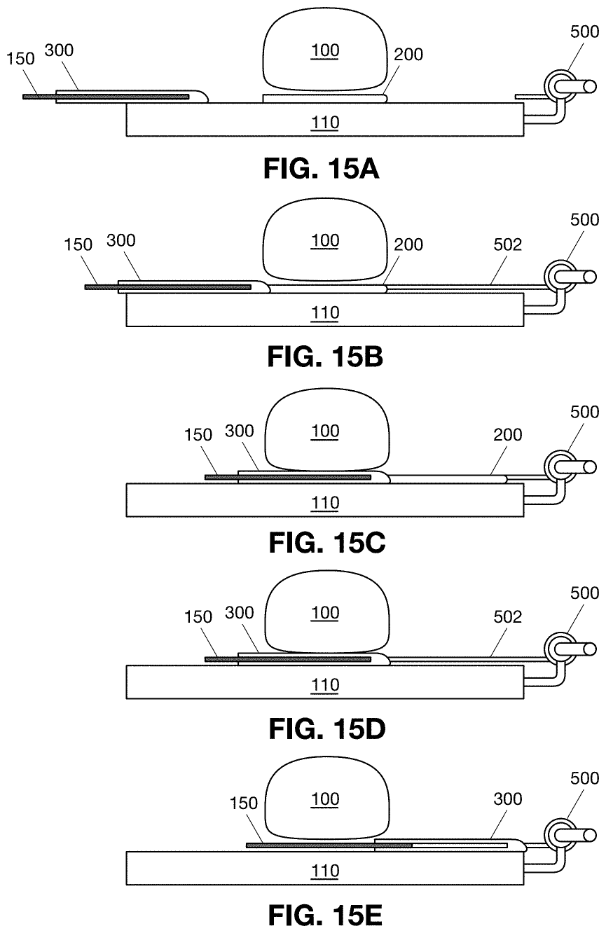

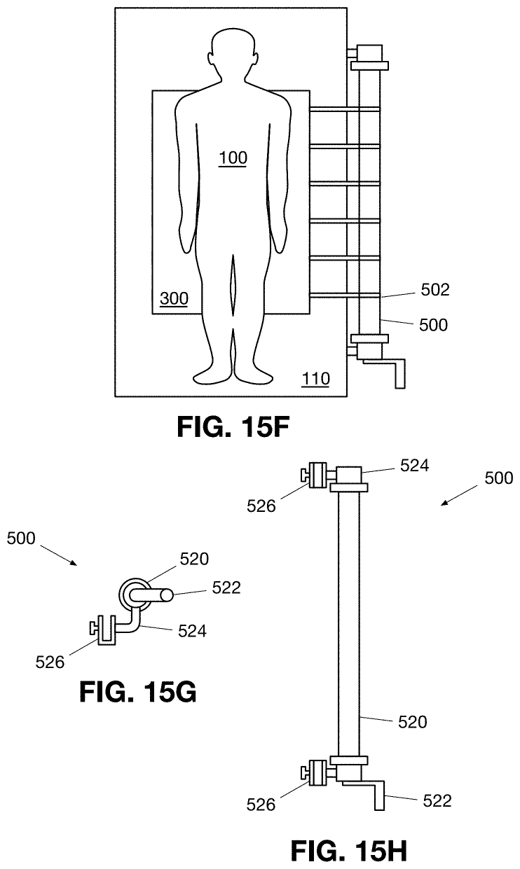

As illustrated in FIGS. 15A through 15F, hand-cranked straps 502 may be used first to pull the roller blanket 300 via advancing rods 200, and then to pull the roller blanket 300 directly. This allows inflexible advancing rods 200 to be removed prior pulling the roller blanket 300 clear of the patient 100, allowing the distance between the patient 100 and the hand-cranked spool 500 to be minimised.

FIG. 15A shows an end elevation view a patient 100 on a bed 110, with a roller blanket 300 positioned on the bed 110 to the left of the patient 100 and containing a wrap 150, an advancing rod 200 already in place under the patient 100, and a hand-cranked spool 500 mounted on the right side of the bed 110. FIG. 15B shows the advancing rod 200 connected on the left to the roller blanket 300 and on the right to a strap 502 from the spool 500. FIG. 15C shows the roller blanket 300 of FIG. 15B pulled to a position under the patient 100 via the advancing rod 200 and hand-cranked strap 502. FIG. 15D shows the advancing rod 200 of FIG. 15C removed, and the strap 502 connected directly to the roller blanket 300. FIG. 15E shows the roller blanket 300 of FIG. 15D pulled partially clear of the wrap 150 via the hand-cranked strap 502, leaving the wrap 150 under the patient 100.

As shown in FIG. 15F, multiple straps 502 are typically used to connect at multiple points along the length of the roller blanket 300 (connected to multiple advancing rods 200, as required), and the spool 500 is of sufficient length to wind in every strap 502.

Spool 500 may be motorised as an alternative to being cranked by hand.

Spool 500 may be a permanent fixture of the bed, or may be semi-permanently attached to the bed 110, e.g. via fasteners such as bolts. As illustrated in FIGS. 15G and 15H, spool 500 may also be attachable to the bed via clamps or similar easily-detached fasteners, e.g. for easy temporary or semi-permanent attachment to the bed 110. FIG. 15G shows an end elevation view of attachable hand-cranked spool 500, comprising a shaft 520, crank handle 522, end brackets 524, and clamp 526 for attaching the spool 500 to the bed 110. FIG. 15H shows a corresponding plan view.

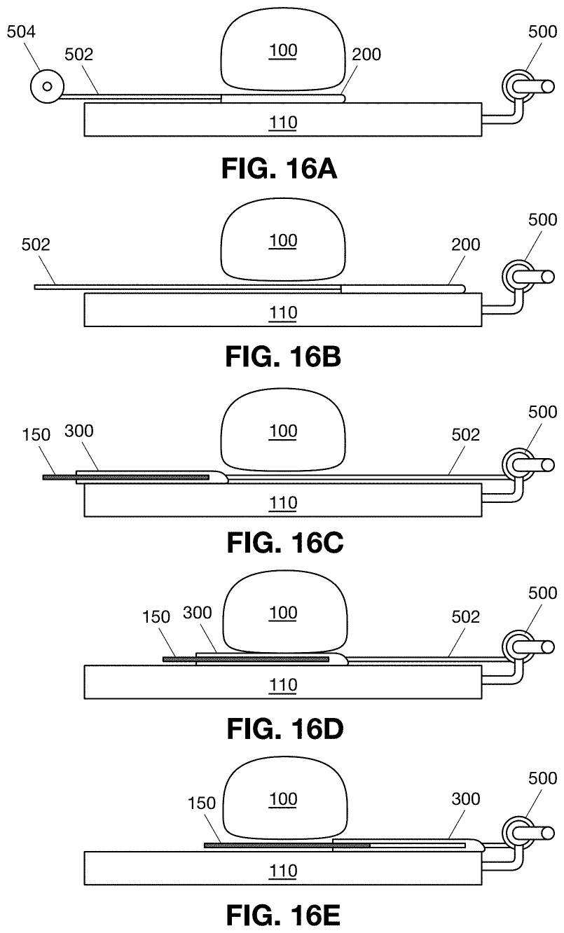

As illustrated in FIGS. 16A through 16E, rather than using inflexible advancing rods 200 to pull the roller blanket 300, they can be used merely to pull straps 502 under the patient. The straps 502 can then be connected to the roller blanket 300 and to the hand-cranked spool 500, and used to pull the roller blanket 300. This can allow the distance between the patient 100 and the hand-cranked spool 500 to be further minimised, e.g. if the roller blanket 300 is pulled by hand the last part of the way from under the patient, or if the straps 502 are connected at successive points along the roller blanket (e.g. the connectors 372 shown in FIG. 11).

FIG. 16A shows an end elevation view of a patient 100 on a bed 100, with an advancing rod 200 already in place under the patient 100, and connected on the left to a strap 502 from a spool 504. FIG. 16B shows the advancing rod 200 pulled clear of the patient 100, bringing the strap 502 with it. FIG. 16C shows the strap 502 connected on the left to a roller blanket 300 containing a wrap 150, and connected on the right to the hand-cranked spool 500. FIG. 16D shows the roller blanket 300 pulled to a position under the patient 100 via the hand-cranked strap 502. FIG. 16E shows the roller blanket pulled partially clear of the wrap 150 via the hand-cranked strap 502, leaving the wrap 150 under the patient 100.

Again as shown in FIG. 15F, multiple straps 502 are typically used to connect at multiple points along the length of the roller blanket 300, and the spool 500 is of sufficient length to wind in every strap 502.

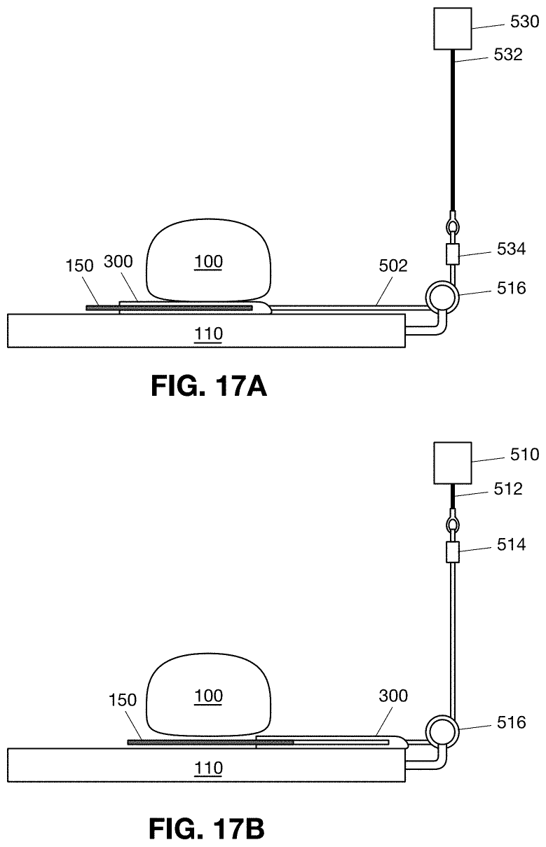

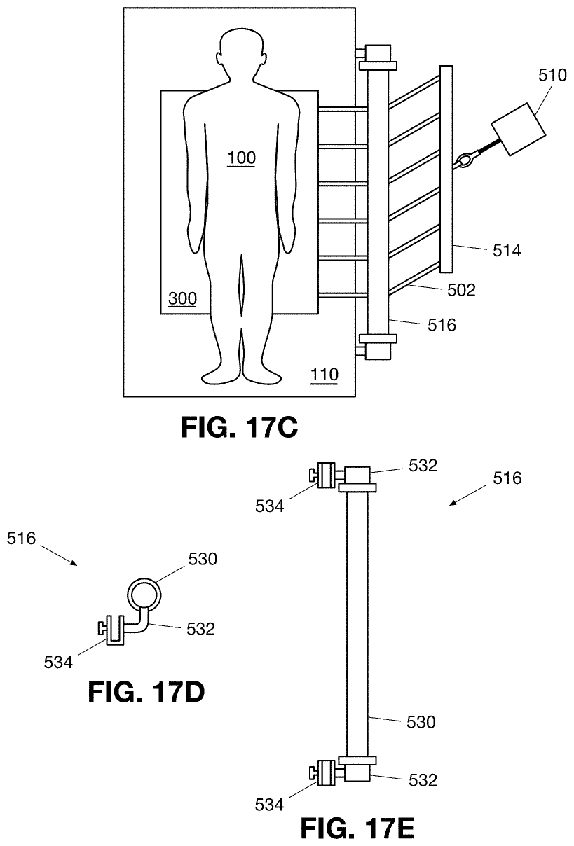

A motorised lift, if available, may be used to pull the straps 502. FIG. 17A shows an end elevation view of a patient 100 on a bed 110, with a strap 502 connected on the left to a roller blanket 300 containing a wrap 150, and on the right to a motorised lift 510 via a force redirection structure in the form of a pulley 516. The motorised lift 510 may be permanently installed on the ceiling above the bed 110, or may be portable. The pulley 516 allows the vertical/upward tensile force of the lift to be redirected so that the straps 502 are pulled horizontally/laterally.

FIG. 17B shows the roller blanket 300 pulled partially clear of the wrap 150 via the strap 502 and the lift 510, leaving the wrap 150 under the patient 100.

As shown in FIG. 17C, multiple straps 502 are typically used to connect at multiple points along the length of the roller blanket 300 (and to multiple advancing rods 200, as required), and pulley 516 is of sufficient length to accommodate all of the straps 502. A spreader bar 514 is similarly used to distribute the single-point force of the lift across all of the straps 502. The spreader bar may be as disclosed in Beed et al, U.S. patent application Ser. No. 17/173,838, “Apparatus and method for reorienting a person”.

Pulley 516 may be a permanent fixture of the bed, or may be semi-permanently attached to the bed 110, e.g. via fasteners such as bolts. As illustrated in FIGS. 17D and 17E, pulley 516 may also be attachable to the bed via clamps or similar easily-detached fasteners, e.g. for easy temporary or semi-permanent attachment to the bed 110. FIG. 17D shows an end elevation view of attachable pulley 516, comprising a shaft 530, end brackets 532, and clamp 534 for attaching the pulley 516 to the bed 110. FIG. 17E shows a corresponding plan view.

Any roller blanket 300 comprising a pair of belts 322 and 330 may be used, or adapted to be used, to transport a patient 100 laterally, e.g. between two beds 110. When a roller blanket 300 is used in this way, it is not required to transport a wrap 150, and may therefore be simplified further if desired. The roller blanket 300 is positioned and removed from under the patient 100 in the usual way, and is propelled (or self-propelled) in the usual way, as previously described.

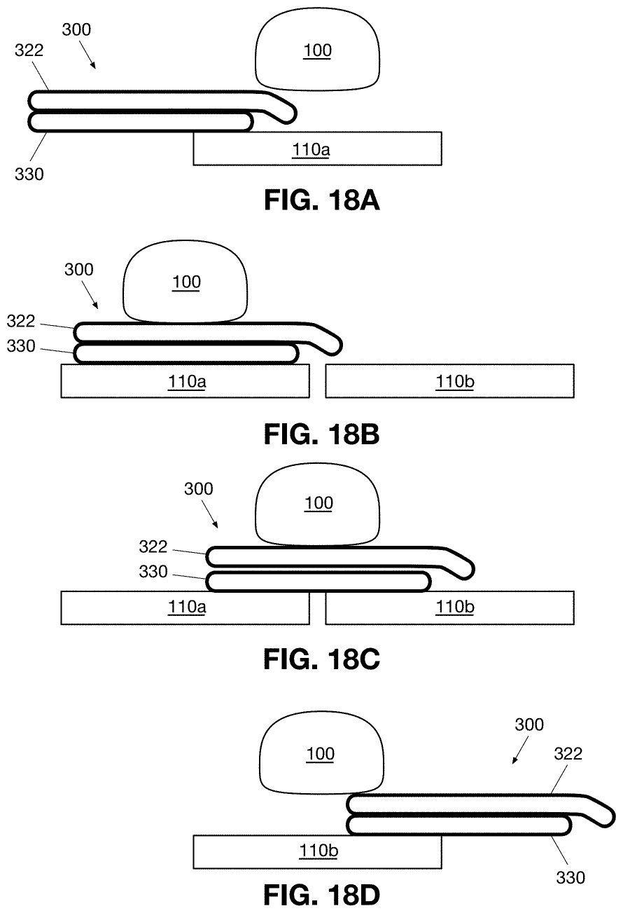

FIGS. 18A through 18D illustrate the procedure for transporting a patient 100 laterally using a roller blanket 300. FIG. 18A shows an end elevation view of a patient 100 lying on a bed 110a, with a roller blanket 300 positioned just under the left side of the patient 100. FIG. 18B shows the roller blanket 300 advanced, in the usual way, to a position directly under the patient 100. During this step both the top belt 322 and bottom belt 330 are driven in unison, e.g. by being directly coupled. FIG. 18C shows the roller blanket 300 in the process of transporting the patient 100 laterally to an adjacent bed 110b. During lateral transport the patient 100 is stationary on the upper belt 322. The upper belt is therefore not driven, and may be locked if desired. If the upper belt 322 is coupled to the lower belt 330, then they are decoupled prior to transport commencing, and recoupled after transport is complete. FIG. 18D shows the roller blanket 300 advanced to just under the right side of the patient, in the process of leaving the patient lying on adjacent bed 110b. During this step both the top belt 322 and bottom belt 330 are once again driven in unison.

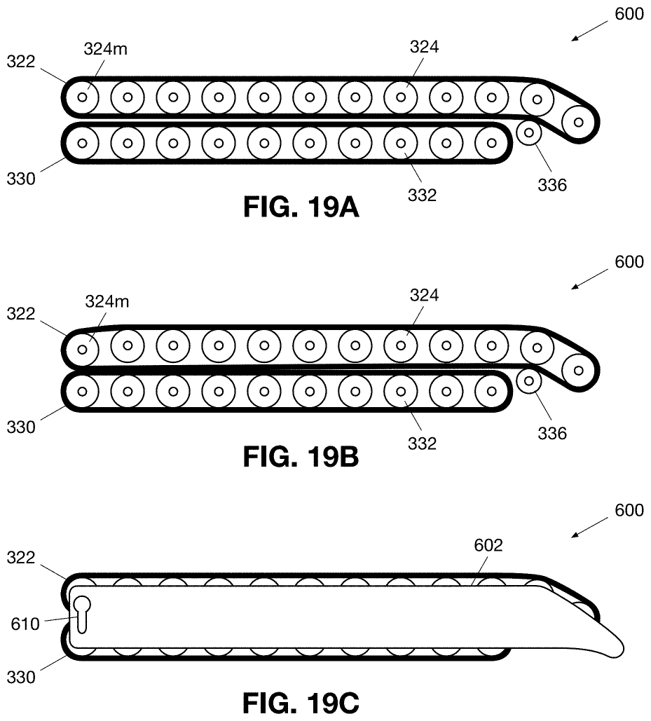

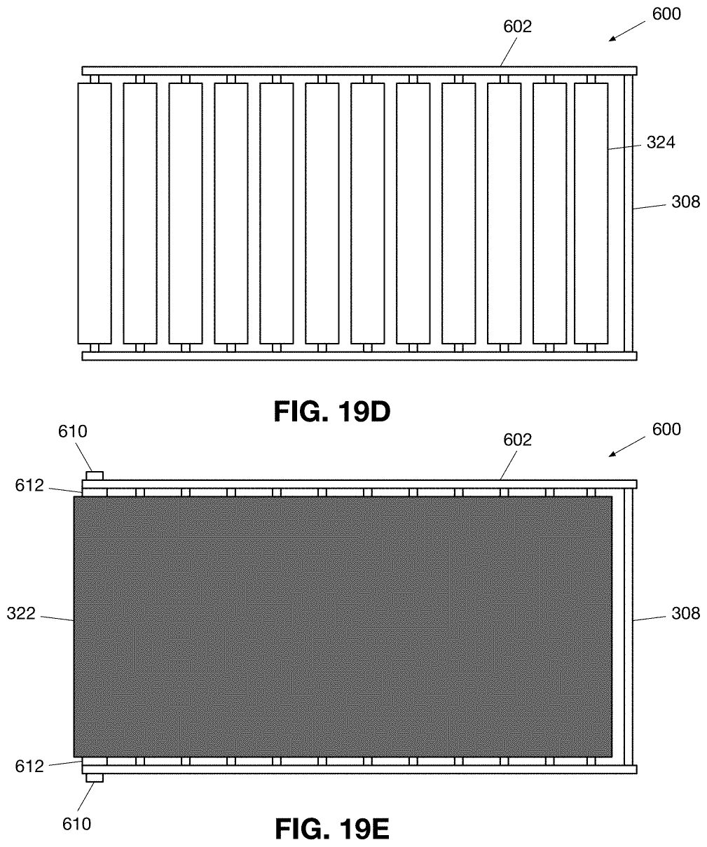

FIG. 19A shows a side elevation view of a roller blanket 600 in accordance with another embodiment, specifically adapted for moving a patient laterally, and not for transporting a wrap 150. The roller blanket 600 comprises a pair of layers. The top layer comprises a belt 322 supported by an array of rollers 324. The bottom layer comprises a belt 330 supported by an array of rollers 332. The top belt 322 and bottom belt 330 are generally separated by a gap, and, unlike e.g. the roller blanket 320 of FIG. 6B, the two layers share a single frame 602 and are therefore in a fixed configuration.

FIG. 19B shows a side elevation view of roller blanket 600 with the top belt 322 in contact with the bottom belt 330 so that they move in unison. The position of rear top roller 324m is vertically adjustable to achieve contact between the belts. In FIG. 19A, roller 324m is in a raised position and the belts are not in contact. In FIG. 19B, roller 324m is in a lowered position and the belts are in contact. In general, any suitable roller 324 (or 332) may be made adjustable to allow coupling of the belts.

FIG. 19C shows a side elevation view of roller blanket 600 with frame 602 in place. A lever 610 allows vertical positioning of rear top roller 324m to effect coupling and decoupling of the belts.

FIG. 19D shows a plan view of roller blanket 600 without the belts in place. FIG. 19E shows a plan view of roller blanket 600 with the belts in place.

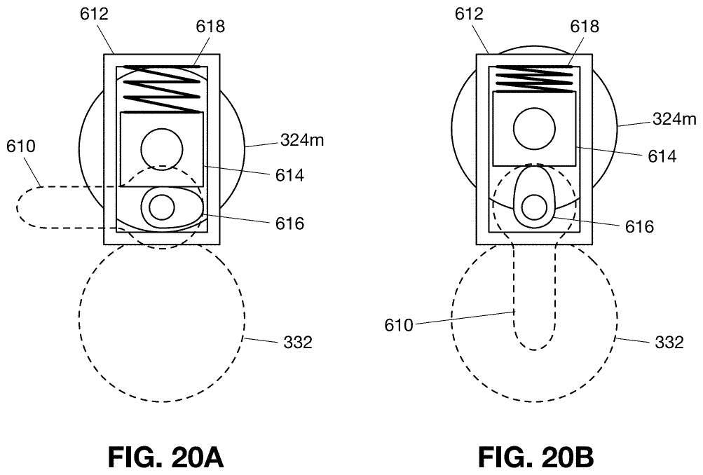

FIG. 20A shows a side elevation view of an embodiment of a mechanism for decoupling the belts of roller blanket 600. FIG. 20A shows the mechanism in a coupled configuration. FIG. 20B shows the mechanism in a decoupled configuration. Mechanisms are provided at both ends of roller 324m.

In the mechanism, roller 324m is held by a block 614 which slides vertically within a housing 612. As shown in FIG. 20A, the lowered position of block 614, and hence roller 324m, is selected by rotating lever 610 to a horizontal orientation. As shown in FIG. 20B, the raised position of block 614, and hence roller 324m, is selected by rotating lever 610 to a vertical orientation. Lever 610 is attached to a cam 616 which pushes on block 614 and thereby translates the rotation of lever 610 into the vertical position of block 614. A spring 618 pushes block 614 in the opposite direction, biasing it downwards towards the lowered position. In an alternative embodiment of the mechanism, spring 618 is below block 614 and biases it upwards towards the raised position, and cam 616 is above block 614 and pushes it downwards towards the lowered position.

In the raised position, part of roller 324m may optionally be pushed against a brake (not shown), to fully immobilise top track 322. Alternatively, a separate brake may be provided. However, it is not essential to fully immobilise top track 322 during lateral transport of the patient 100, particularly if the patient is being steadied by care staff during the procedure.

Either belt may be motorised, e.g. per the upper layer of roller blanket 380 and the lower layer of roller blanket 390. Both belts may be motorised so that they can be driven independently, i.e. in unison or one at a time, obviating the need for a coupling mechanism.

The coupling mechanism and/or brake may be powered rather than manual, particularly if power is available for a drive motor.

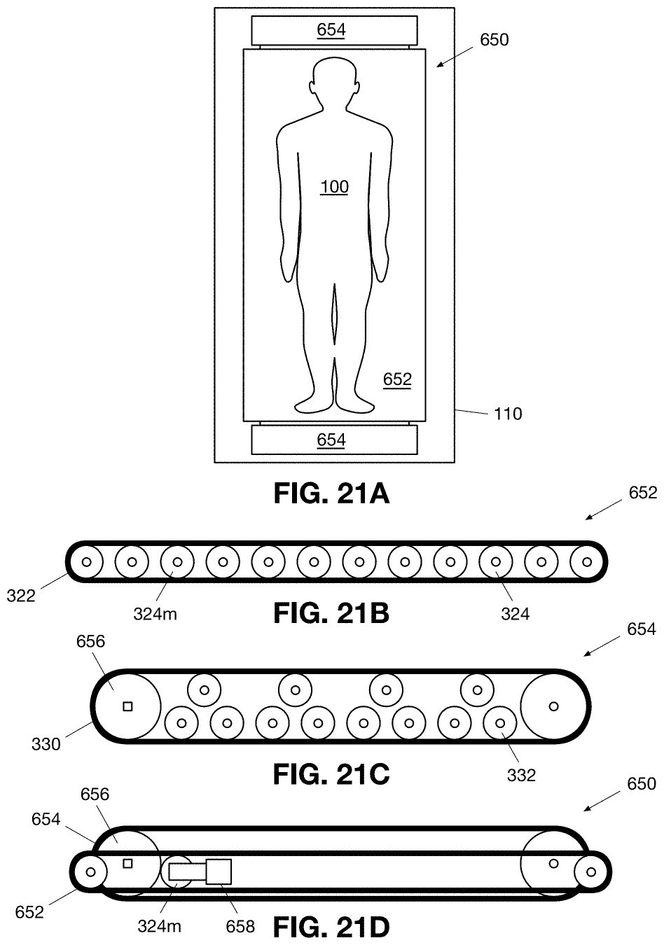

A roller blanket 300 may be optimised further when its sole purpose is transferring a patient 100 laterally. FIGS. 21A through 21D illustrate an optimised transfer roller blanket 650, where the usually stacked layers of the roller blanket 300 are instead adjacent to each other. By moving the bottom layer out from under the top layer, the top layer can be positioned closer to the surface of the bed 110, making it easier to drive the roller blanket 650 under a patient 100.

FIG. 21A shows a plan view of a patient 100 lying on a bed 110 on top of a transfer roller blanket 650. The roller blanket 650 comprises a central conveyor 652 and a pair of outside tracks 654. FIG. 21B shows a side elevation view of the central conveyor 652, comprising a belt 322 supported by a set of rollers 324. It is analogous to and serves the same function as the top layer of any roller blanket 300. FIG. 21C shows a side elevation view of the outside track 654, comprising a belt 330 supported by a set of rollers 332. It is analogous to and serves the same function as the bottom layer of any roller blanket 300. Although the transfer roller blanket 650 can be propelled by pulling in the usual way, FIG. 21C shows the track 654 with a motorised drive roller 656, allowing it to be self-propelled. FIG. 21D shows a side elevation view of the entire roller blanket 650, with extraneous rollers omitted for clarity. As illustrated in FIG. 21D, the central conveyor 652 is elevated slightly above the surface of the bed 110, while the outside tracks 654 are in contact with the bed. This allows the central conveyor 650 to be stationary or moving in the opposite direction to the direction of movement of the roller blanket 650, without experiencing any friction with the surface of the bed.

As shown in FIG. 21D, one roller 324m of the central conveyor 652 is partially coupled to the drive roller 656 to allow the drive roller 656 to also drive the central conveyor. To allow this, roller 324m protrudes from the central conveyor 652 into at least one of the outside tracks 654, where it makes direct contact with part of the drive roller 656. Rollers 332 are set back where necessary to prevent interference. As previously described, when the roller blanket 650 is being driven to/from under the patient 100, the two belts 322 and 330 need to be driven at the same speed but in opposite directions, so that the roller blanket 650 moves relative to the bed while the patient 100 remains immobile, with no relative movement between the top belt 322 and the underside of the patient 100. Once the roller blanket 650 is under the patient 100 and the patient is being transferred laterally, the central conveyor 652 needs to remain stationary while the outside tracks 654 propel the roller blanket 650, and hence the patient 100, laterally. To allow the central conveyor 652 to be stationary while the outside tracks 654 are moving, roller 324m is temporarily decoupled from the drive roller 656. Decoupling can be manual, as described in relation to FIGS. 20A and 20B, or, as shown in FIG. 21D, a decoupling actuator 658 can be used to move roller 324m out of contact with the drive roller 656. The decoupling actuator can be any suitable actuator driven electrically, hydraulically or pneumatically.

Assuming the availability of a lateral transfer device, and in particular the transfer roller blanket 650, a wrap 150 can be positioned under a patient 100 by transferring the patient 100 off the bed 100 using the transfer device (e.g. 650), placing the wrap 150 on the bed 110, and then transferring the patient 100 back onto the bed 110, using the transfer device (e.g. 650), and therefore onto the wrap 150.

Although roller blanket 650 has been described specifically in relation to the lateral transfer of a patient 100, more generally it represents a universal class of devices for transferring bulky loads.

Persons skilled in the art will appreciate that there are yet more alternative implementations and modifications possible, and that the above examples are only illustrations of one or more implementations.

What is claimed is:

1. A system for positioning an article under a person, comprising:
an apparatus comprising:
a first cover structure and a second cover structure, each of the first cover structure and the second cover structure having a first surface and a second surface opposite the first surface, the first surface being movable in a first direction and the second surface moving in a second direction opposite the first direction in response to the first surface moving in the first direction; and
a coupling structure coupling the first cover structure and the second cover structure, the coupling structure being operable to space the first cover structure and the second cover structure to enable the article to be positioned between the second surface of the first cover structure and the second surface of the second cover structure,
wherein the first direction of the first cover structure is substantially aligned with the first direction of the second cover structure,
wherein the second direction of the first cover structure is substantially aligned with the second direction of the second cover structure, and
wherein movement of the first surface of the first cover structure and the first surface of the second cover structure in the first direction causes the second surface of the first cover structure and the second surface of the second cover structure to move the article positioned therebetween in the second direction by the second surface of the first cover structure and the second surface of the second cover structure.

2. The system of claim 1, wherein the first cover structure includes a frame structure, and an array of rotatable elements rotatably mounted on the frame structure, each rotatable element of the array of rotatable elements being rotatable about a rotation axis that is substantially perpendicular to the first direction and substantially parallel to the first surface and the second surface.

3. The system of claim 2, wherein the frame structure includes a plurality of rods on which the array of rotatable elements are rotatably positioned.

4. The system of claim 3, wherein each rotatable element in the array of rotatable elements has a circular cross-section.

5. The system of claim 4, wherein the array of rotatable elements provides the first surface and the second surface of the first cover structure.

6. The system of claim 5, wherein the first cover structure and the second cover structure are generally planar, and wherein the first cover structure has an end portion that extends further in the first direction than the second cover structure, the end portion extending towards a plane of the second cover structure.

7. The system of claim 1, wherein the first cover structure includes a frame structure around which is rotatably positioned at least one endless belt that provides the first surface along one portion thereof, and the second surface along another portion thereof.

8. The system of claim 7, wherein the first cover structure and the second cover structure are generally planar, and wherein the first cover structure having an end portion that extends further in the first direction than the second cover structure, the end portion extending towards a plane of the second cover structure.

9. The system of claim 1, further comprising:
a set of advancing members, each advancing member of the set of advancing members having a leading end and a connecting end opposite the leading end, each of the set of advancing members being insertable via the leading end thereof between a person and a resting surface on which the person is resting, the connecting end of each advancing member of the set of advancing members being couplable to the apparatus towards an end thereof to draw the apparatus between the person and the resting surface.

10. The system of claim 9, further comprising at least one pull structure coupleable to the set of advancing members to facilitate movement of the apparatus between the person and the resting surface.

11. The system of claim 9, further comprising a manual drive connectable to the set of advancing members to manually move the apparatus laterally between the person and the resting surface.

12. The system of claim 10, wherein the at least one pull structure is one pull structure, wherein the one pull structure includes a hoist connector interface for connection to a hoist, and wherein the apparatus further comprises a force redirection structure around which the leading ends of the set of advancing members are positioned for redirecting an upward tensile force of the hoist to act laterally on the apparatus.

13. The system of claim 1, further comprising an isolation structure that is controllable to selectively isolate the second surface of the first cover structure from the second surface of the second cover structure to inhibit contact therebetween.

14. The system of claim 1, wherein the apparatus further comprises a motor for driving at least one of the first surface of the first cover structure and the first surface of the second cover structure to move in the first direction.

15. A method of positioning an article between a person and a resting surface, comprising:
positioning a portion of the article between a first cover structure and a second cover structure of an apparatus, each of the first cover structure and the second cover structure having a first surface and a second surface opposite the first surface, the first surface being movable in a first direction and the second surface moving in a second direction opposite the first direction in response to the first surface moving in the first direction, the apparatus having a coupling structure coupling the first cover structure and the second cover structure, the coupling structure spacing the first cover structure and the second cover structure to enable the article to be positioned between the second surface of the first cover structure and the second surface of the second cover structure, wherein the first direction of the first cover structure is substantially aligned with the first direction of the second cover structure, wherein the second direction of the first cover structure is substantially aligned with the second direction of the second cover structure, wherein movement of the first surface of the first cover structure and the first surface of the second cover structure in the first direction causes the second surface of the first cover structure and the second surface of the second cover structure to move the article positioned therebetween in the second direction by the second surface of the first cover structure and the second surface of the second cover structure;
wrapping a first end of the article around a first end of the second cover structure; and
moving the apparatus between the person and the resting surface with the first end of the second cover structure preceding a remainder of the cover structure to deposit the article between the person and the resting surface.

16. The method of claim 15, further comprising:
inserting a leading end of each of a set of advancing members between the person and the resting surface;
pushing each of the set of advancing members until the leading ends of the set of advancing members protrudes from under the person;
connecting a trailing edge of each of the advancing members to the apparatus towards an end thereof; and
drawing the apparatus between the person and the resting surface by applying a tensile force on the leading ends of the set of advancing members.

17. The method of claim 16, further comprising:
coupling each advancing member of the set of advancing members to at least one pull structure, and
wherein drawing the apparatus includes pulling the at least one pull structure.

18. The method of claim 17, further comprising:
positioning the leading ends of the set of advancing members around a force direction translation structure;
connecting the leading ends of the set of advancing members to a pull structure;
connecting a hoist to the pull structure; and
operating the hoist to pull the leading ends of the set of advancing members.

19. A method of moving a person positioned on a resting surface, comprising:
positioning an apparatus adjacent to the person, the apparatus including a first cover structure and a second cover structure, each of the first cover structure and the second cover structure having a first surface and a second surface opposite the first surface, the first surface being movable in a first direction and the second surface moving in a second direction opposite the first direction in response to the first surface moving in the first direction, the apparatus further including a coupling structure coupling the first cover structure and the second cover structure, the apparatus further including an isolation structure that is controllable to selectively isolate the second surface of the first cover structure from the second surface of the second cover structure to inhibit contact therebetween;
controlling the isolation structure to put the second surface of the first cover structure in contact with the second surface of the second cover structure;
driving the apparatus under the person;
controlling the isolation structure to isolate the second surface of the first cover structure from the second surface of the second cover structure;
driving the apparatus to move the person to a target position;
controlling the isolation structure to put the second surface of the first cover structure in contact with the second surface of the second cover structure; and
driving the apparatus from between the person and the resting surface.
